(19) United States
(12) Patent Application Publication
(10) Pub. No.: US 2026/0020030 A1
(43) Pub. Date: Jan. 15, 2026

(54) RESOURCE CONFIGURATION METHOD AND APPARATUS, TERMINAL, DEVICE, AND STORAGE MEDIUM

(71) Applicant: VIVO MOBILE COMMUNICATION CO., LTD., Dongguan (CN)

(72) Inventors: Erhao SONG, Dongguan (CN); Wei BAO, Dongguan (CN)

(73) Assignee: VIVO MOBILE COMMUNICATION CO., LTD., Dongguan (CN)

(21) Appl. No.: 19/334,935

(22) Filed: Sep. 21, 2025

Related U.S. Application Data
(63) Continuation of application No. PCT/CN2024/082773, filed on Mar. 20, 2024.

(30) Foreign Application Priority Data
Mar. 24, 2023 (CN) 202310302449.2

(51) Int. Cl. H04W 72/21; H04W 36/08; H04W 56/00; H04W 72/23; H04W 74/0833

(52) U.S. Cl. CPC H04W 72/21; H04W 36/08; H04W 56/0045; H04W 72/23; H04W 74/0833

(57) ABSTRACT

A resource configuration method and apparatus, a terminal, a device, and a storage medium, are provided. The resource configuration method, performed by a first network node, includes: obtaining configuration information of an uplink resource of a target cell, where the uplink resource is shared by a plurality of terminals served by the first network node; and sending a first command, where the first command is used to allocate at least a part of the obtained uplink resource of the target cell for a target terminal in the plurality of terminals, and indicate the target terminal to obtain a Timing Advance (TA) value of the target cell based on the uplink resource or perform handover to the target cell based on the uplink resource, and the target cell belongs to a second network node.

### CROSS-REFERENCE TO RELATED APPLICATIONS

This application is a continuation of International Application No. PCT/CN2024/082773, filed Mar. 20, 2024, which claims priority to Chinese Patent Application No. 202310302449.2, filed Mar. 24, 2023. The entire contents of each of the above-referenced applications are expressly incorporated herein by reference.

### TECHNICAL FIELD

This application pertains to the field of communication technologies, and specifically relates to a resource configuration method and apparatus, a terminal, a device, and a storage medium.

### BACKGROUND

During L1/L2-Triggered Mobility (LTM) handover, to reduce an uplink synchronization latency of an LTM process, a Contention-Free Random Access (CFRA) resource or an uplink Configured Grant (CG) transmission resource needs to be preconfigured for each terminal.

However, if the terminal is not handed over to a target cell for a long time, a resource reserved by the target cell for the terminal is wasted. Therefore, a resource configuration method and apparatus, a terminal, a device, and a storage medium need to be provided, to appropriately configure resources of the target cell in an LTM handover process, and avoid or reduce a resource waste problem.

### SUMMARY

Embodiments of this application provide a resource configuration method and apparatus, a terminal, a device, and a storage medium.

According to a first aspect, a resource configuration method is provided, applied to a first network node. The method includes:
obtaining configuration information of an uplink resource of a target cell, where the uplink resource is shared by a plurality of terminals served by the first network node; and
sending a first command, where the first command is used to allocate at least a part of the obtained uplink resource of the target cell for a target terminal in the plurality of terminals, and indicate the target terminal to obtain a timing advance TA value of the target cell based on the uplink resource or perform handover to the target cell based on the uplink resource, and the target cell belongs to a second network node.

According to a second aspect, a resource configuration method is provided, applied to a second network node. The method includes:
sending configuration information of an uplink resource of a target cell, where the uplink resource is shared by a plurality of terminals served by a first network node, and the target cell belongs to the second network node; and
receiving first uplink information on the uplink resource, where the first uplink information is information used by a target terminal in the plurality of terminals to obtain a TA value or perform cell handover.

According to a third aspect, a resource configuration method is provided, applied to a target terminal. The method includes:
receiving a first command, where the first command is used to indicate the target terminal to obtain a TA value based on configuration information of an uplink resource of a target cell or perform cell handover based on configuration information of an uplink resource of a target cell, the uplink resource is shared by a plurality of terminals including the target terminal that are served by a first network node, and the target cell belongs to a second network node; and
sending first uplink information based on the uplink resource, where the first uplink information is used to obtain the TA value or perform cell handover.

According to a fourth aspect, a resource configuration apparatus is provided. The apparatus includes:
an obtaining module, configured to obtain configuration information of an uplink resource of a target cell, where the uplink resource is shared by a plurality of terminals served by a first network node; and
a first sending module, configured to send a first command, where the first command is used to allocate at least a part of the obtained uplink resource of the target cell for a target terminal in the plurality of terminals, and indicate the target terminal to obtain a timing advance TA value of the target cell based on the uplink resource or perform handover to the target cell based on the uplink resource, and the target cell belongs to a second network node.

According to a fifth aspect, a resource configuration apparatus is provided. The apparatus includes:
a second sending module, configured to send configuration information of an uplink resource of a target cell, where the uplink resource is shared by a plurality of terminals served by a first network node, and the target cell belongs to a second network node; and
a second receiving module, configured to receive first uplink information on the uplink resource, where the first uplink information is information used by a target terminal in the plurality of terminals to obtain a TA value or perform cell handover.

According to a sixth aspect, a resource configuration apparatus is provided. The apparatus includes:
a third receiving module, configured to receive a first command, where the first command is used to indicate the target terminal to obtain a TA value based on configuration information of an uplink resource of a target cell or perform cell handover based on configuration information of an uplink resource of a target cell, the uplink resource is shared by a plurality of terminals including the target terminal that are served by a first network node, and the target cell belongs to a second network node; and
a third sending module, configured to send first uplink information based on the uplink resource, where the first uplink information is used to obtain the TA value or perform cell handover.

According to a seventh aspect, a terminal is provided. The terminal includes a processor and a memory. The memory stores a program or instructions capable of running on the processor, and when the program or the instructions are executed by the processor, the steps of the resource configuration method according to the third aspect are implemented.

According to an eighth aspect, a terminal is provided, including a processor and a communication interface. The processor is configured to run a program or instructions, so that when the program or the instructions are executed by the processor, the steps of the resource configuration method according to the third aspect are implemented. The communication interface is configured to be coupled to the processor.

According to a ninth aspect, a network side device is provided. The network side device includes a processor and a memory. The memory stores a program or instructions capable of running on the processor, and when the program or the instructions are executed by the processor, the steps of the resource configuration method according to the first aspect or the second aspect are implemented.

According to a tenth aspect, a network side device is provided, including a processor and a communication interface. The processor is configured to run a program or instructions, so that when the program or the instructions are executed by the processor, the steps of the resource configuration method according to the first aspect or the second aspect are implemented. The communication interface is configured to be coupled to the processor.

According to an eleventh aspect, a readable storage medium is provided. The readable storage medium stores a program or instructions, and when the program or the instructions are executed by a processor, the steps of the resource configuration method according to the first aspect, the second aspect, or the third aspect are implemented.

According to a twelfth aspect, a wireless communication system is provided, including a terminal and a network side device. The terminal may be configured to perform the steps of the resource configuration method according to the third aspect, and the network side device may be configured to perform the steps of the resource configuration method according to the first aspect or the second aspect.

According to a thirteenth aspect, a chip is provided. The chip includes a processor and a communication interface, the communication interface is coupled to the processor, and the processor is configured to run a program or instructions to implement the resource configuration method according to the first aspect, or implement the resource configuration method according to the second aspect, or implement the resource configuration method according to the third aspect.

According to a fourteenth aspect, a computer program/program product is provided. The computer program/program product is stored in a storage medium. The program/program product is executed by at least one processor to implement the resource configuration method according to the first aspect, or implement the resource configuration method according to the second aspect, or implement the resource configuration method according to the third aspect.

### BRIEF DESCRIPTION OF DRAWINGS

FIG. 1 is a block diagram of a wireless communication system according to an embodiment of this application;

FIG. 2 is a diagram of a system architecture of a gNB according to an embodiment of this application;

FIG. 3 is a schematic diagram of intra-DU LTM handover according to an embodiment of this application;

FIG. 4 is a schematic diagram of intra-CU and inter-DU LTM handover according to an embodiment of this application;

FIG. 5 is a flowchart of steps of a resource configuration method according to an embodiment of this application;

FIG. 6 is a schematic flowchart of Implementation 1 according to an embodiment of this application;

FIG. 7 is a schematic flowchart of Implementation 2 according to an embodiment of this application;

FIG. 8 is a schematic flowchart of Implementation 3 according to an embodiment of this application;

FIG. 9 is a schematic flowchart of Implementation 4 according to an embodiment of this application;

FIG. 10 is a schematic flowchart of Implementation 5 according to an embodiment of this application;

FIG. 11 is a schematic flowchart of Implementation 6 according to an embodiment of this application;

FIG. 12 is a flowchart of steps of a resource configuration method based on a second network node according to an embodiment of this application;

FIG. 13 is a flowchart of steps of a resource configuration method based on a target terminal according to an embodiment of this application;

FIG. 14 is a schematic diagram of a structure of a resource configuration apparatus according to an embodiment of this application;

FIG. 15 is a schematic diagram of a structure of a resource configuration apparatus according to an embodiment of this application;

FIG. 16 is a schematic diagram of a structure of a resource configuration apparatus according to an embodiment of this application;

FIG. 17 is a schematic diagram of a structure of a communication device according to an embodiment of this application;

FIG. 18 is a schematic diagram of a hardware structure of a terminal according to an embodiment of this application;

FIG. 19 is a schematic diagram of a structure of a network side device according to an embodiment of this application; and

FIG. 20 is a schematic diagram of a structure of another network side device according to an embodiment of this application.

### DETAILED DESCRIPTION

The following describes technical solutions in embodiments of this application with reference to accompanying drawings in the embodiments of this application. Clearly, the described embodiments are merely some rather than all of the embodiments of this application. All other embodiments obtained by a person of ordinary skill in the art based on embodiments of this application shall fall within the protection scope of this application.

The terms “first,” “second,” and the like in this application are used to distinguish between similar objects instead of describing a specified order or sequence. It should be understood that, terms used in this way are interchangeable under appropriate circumstances, so that embodiments of this application can be implemented in a sequence other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions, that is, solution 1: including A and not including B; solution 2: including B and not including A; and solution 3: including both A and B. The character “/” generally represents an “or” relationship between associated objects.

The term “indication” in this application may be either a direct indication (or an explicit indication) or an indirect indication (or an implicit indication). The direct indication may be understood as: A sender explicitly notifies, in a sent indication, a receiver of specific information, an operation that needs to be performed, a requested result, or other content. The indirect indication may be understood as: The receiver determines corresponding information based on the indication sent by the sender, or performs determining based on the indication sent by the sender, and determines, based on a determining result, the operation that needs to be performed or the requested result.

It should be noted that, a technology described in embodiments of this application is not limited to a Long Term Evolution (LTE)/LTE-Advanced (LTE-A) system, and may be further applied to other wireless communication systems, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency-Division Multiple Access (SC-FDMA) system, or another system. The terms “system” and “network” are often used interchangeably in embodiments of this application. The technology described may be used for the systems and radio technologies described above, as well as other systems and radio technologies. The following describes a New Radio (NR) system for illustrative purposes, and NR terms are used in most of the following descriptions. However, these technologies are also applicable to systems such as a 6th Generation (6G) communication system other than the NR system.

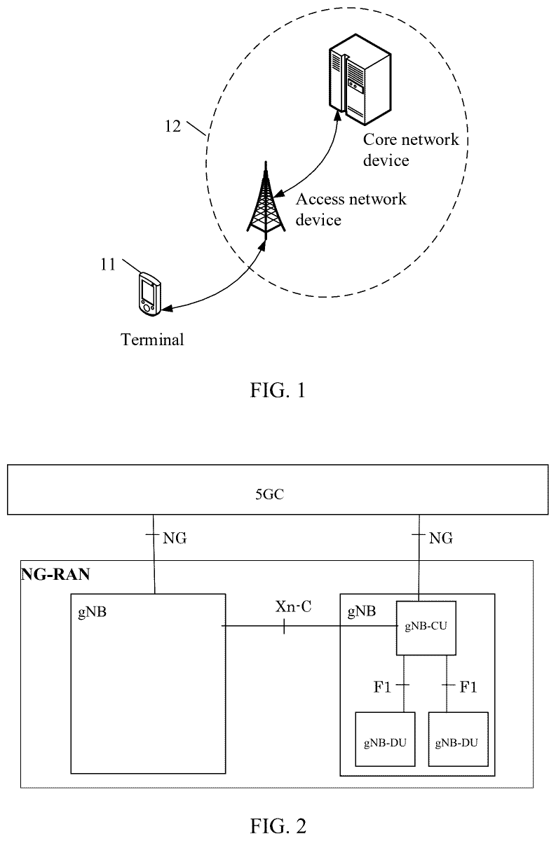

FIG. 1 is a block diagram of a wireless communication system to which an embodiment of this application is applicable. The wireless communication system includes a terminal 11 and a network side device 12. The terminal 11 may be a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a flight vehicle, Vehicle User Equipment (VUE), ship-mounted equipment, Pedestrian User Equipment (PUE), a smart home (a home device with a wireless communication function, for example, a refrigerator, a television, a laundry machine, or furniture), a game console, a personal computer, a teller machine, a self-service machine, or another terminal side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), a Wireless Fidelity (WiFi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a Home NodeB (HNB), a home evolved NodeB, a Transmission Reception Point (TRP), or another proper term in the art. The base station is not limited to a specific technical term, provided that the same technical effect is achieved. It should be noted that in embodiments of this application, only a base station in an NR system is used as an example for description, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), a Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that in embodiments of this application, only a core network device in an NR system is used as an example for description, and a specific type of the core network device is not limited.

FIG. 2 is a diagram of a system architecture of a gNB to which the embodiments are applicable. As shown in FIG. 2, an NR access network splits the gNB into a central unit gNB-CU and a distributed unit gNB-DU, and the central unit and the distributed unit are connected via an F1 interface. Each gNB includes only one central unit CU, and includes one or more distributed units DUs. One distributed unit DU includes one or more cells (cell). The CU includes a Packet Data Convergence Protocol (PDCP) and an above protocol stack. The DU includes a protocol stack below the Packet Data Convergence Protocol (PDCP) layer: Radio Link Control (RLC), Medium Access Control (MAC), and a Physical (PHY) layer. On a control plane, the Central Unit (CU) includes Radio Resource Control (RRC) and a Control-plane PDCP (PDCP-C). On a user plane, the central unit CU includes a Service Data Adaptation Protocol (SDAP) and a User-plane PDCP (PDCP-U).

LTM (L1/L2-Triggered Mobility) refers to an inter-cell mobility mechanism based on layer 1/layer 2 signaling, and triggers inter-cell handover based on L1/L2 signaling. In a Release18 mobility enhancement project, LTM supports two types of handover scenarios: intra-DU (the same distributed unit) and intra-CU and inter-DU (the same central unit and different distributed units).

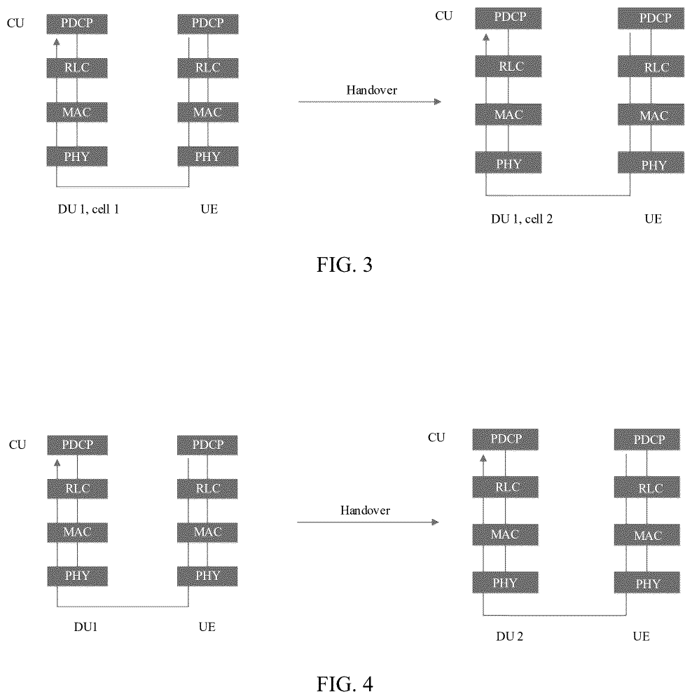

In some implementations, FIG. 3 is a schematic diagram of intra-DU LTM handover. Intra-DU indicates that a terminal is handed over between different cells (cell) in a same distributed unit DU served by a same central unit CU. As shown in FIG. 3, the terminal UE is handed over from a cell 1 of a distributed unit DU 1 served by the central unit CU to a cell 2 of the distributed unit DU 1. FIG. 4 is a schematic diagram of intra-CU and inter-DU LTM handover. Intra-CU and inter-DU indicate that a terminal UE is handed over between cells of different distributed units DUs served by a same central unit CU. As shown in FIG. 4, the terminal UE is handed over from a cell of a distributed unit DU 1 served by the central unit CU to a cell of a distributed unit DU 2 served by the central unit CU.

In a related technology, to reduce an uplink synchronization latency of an LTM process, that is, LTM handover interruption time caused by uplink synchronization (random access process), the 3rd Generation Partnership Project (3GPP) is discussing a solution based on early TA acquisition (early-RACH acquisition) or RACH-less (RACH-less). When the foregoing solution is performed, UE needs to obtain in advance a Timing Advance (TA) value of a target cell, and an uplink resource required for indicating handover completion to the target cell. In the solution based on early TA acquisition (early-RACH acquisition), the target cell allocates a CFRA resource for the terminal UE, and the UE performs RACH to the target cell before handover is initiated, to obtain the TA value of the target cell. In the solution based on RACH-less (RACH-less), the target cell needs to allocate an uplink resource for the UE in a dynamic scheduling or CG scheduling manner, so that the UE transmits a handover complete indication on the corresponding resource. In this solution, the UE does not perform RACH in a handover process, and the TA value of the target cell is obtained in an early-RACH process, or the TA value of the target cell does not need to be obtained, like that of a source cell (a cell in which the UE is located).

Random access is classified into two types: 4-step random access and 2-step random access. Both types support Contention-Based Random Access (CBRA) and Contention-Free Random Access (CFRA). A 4-step CBRA procedure is as follows: (1) UE sends a RACH Msg1 including a preamble to a gNB through a PRACH channel. (2) The UE monitors, in a configured time window, a RACH Msg2, that is, a Random Access Response (RAR), sent by a network. (3) After receiving the RAR, the UE sends a RACH Msg3 by using an uplink resource allocated by the network. (4) The UE monitors a RACH Msg4 (Contention Resolution). If the contention resolution fails, the UE falls back to transmission of the RACH Msg1. A 4-step CFRA procedure is as follows: (1) UE sends, to a gNB, a RACH Msg1 including a specific preamble allocated by a network. (2) The UE detects a RACH Msg2, that is, an RAR, sent by the network, and the random access process ends.

In an NR system, for a requirement of a low-latency service or a periodic service, the NR system supports an uplink semi-static Configured Grant (CG) transmission manner, to reduce signaling exchange procedures, and guarantee a low-latency requirement. A resource for configured grant transmission may be semi-statically configured by using RRC signaling. When service data arrives, UE may send the data on a configured grant uplink channel (a Physical Uplink Shared Channel (PUSCH)). NR supports two types of CG PUSCHs: type 1 (after an RRC parameter is configured, UE can transmit data on the CG PUSCH) and type 2 (only after an RRC parameter is configured and Downlink Control Information (DCI) activates the CG PUSCH, UE can transmit data on the CG PUSCH).

In a related technology, in an inter-DU scenario, because there is a relatively high interface latency during interaction between an S-DU (a first network node, that is, a network node to which a cell in which a terminal is located belongs) and a T-DU (a first network node, that is, a network node to which a target cell that the terminal needs to be handed over to belongs), a dynamic resource allocation method is not suitable. However, for a static configuration method, an LTM target cell of the T-DU needs to preconfigure, for each UE, a CFRA resource used for obtaining a TA, and a CG resource required for indicating handover completion to the target cell after a handover command is received. If the UE is not handed over to the target cell for a long time, the CFRA resource or the CG resource reserved by the target cell for the UE is wasted.

To improve a related technology, embodiments of this application provide a resource configuration method, to share resources of a target cell between a plurality of terminals, and resolve a problem that resources are wasted because a terminal is not handed over for a long time.

The resource configuration method provided in the embodiments of this application is described in detail below with reference to the accompanying drawing by using some embodiments and application scenarios thereof.

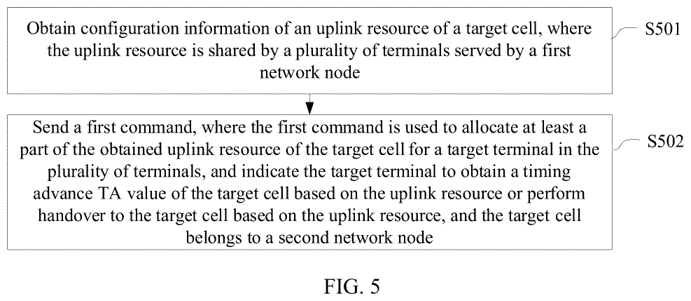

A first aspect of the embodiments of this application provides a resource configuration method. The method is applied to a first network node. Referring to FIG. 5, FIG. 5 is a flowchart of steps of a resource configuration method. As shown in FIG. 5, the resource configuration method may include the following steps.

Step S501: Obtain configuration information of an uplink resource of a target cell, where the uplink resource is shared by a plurality of terminals served by the first network node.

Step S502: Send a first command, where the first command is used to allocate at least a part of the obtained uplink resource of the target cell for a target terminal in the plurality of terminals, and indicate the target terminal to obtain a timing advance TA value of the target cell based on the uplink resource or perform handover to the target cell based on the uplink resource, and the target cell belongs to a second network node.

The first network node and the second network node may be a network side device, a distributed unit DU, or a CU/gNB, or may be any usable TRP or Access Point (AP) in 6G. In this embodiment, the first network node refers to a unit to which a cell (cell) in which the target terminal is located belongs. The target cell is a cell to which the target terminal is to be handed over, and the second network node is a unit to which the target cell belongs. A handover process of the target terminal is a process of handover from a source cell in which the target terminal is currently located to the target cell, and correspondingly, is also a process of handover from the first network node to the second network node. The first network node and the second network node may be a same network node/distributed unit, or may be different network nodes/distributed units. When the first network node and the second network node are the same network node/distributed unit, the target terminal performs LTM handover in an intra-DU (same network node/distributed unit) scenario. When the first network node and the second network node are two different network nodes/distributed units that belong to a same central network node/central unit, the target terminal performs LTM handover in an intra-CU and inter-DU (same central network node/central unit and different network nodes/distributed units) scenario. It should be noted that, when whether the first network node and the second network node are a same network node/distributed unit is not mentioned in any subsequent embodiment, it indicates that a handover scenario is any one of the foregoing scenarios.

The terminal refers to User Equipment (UE), for example, the terminal in FIG. 1. In this embodiment of this application, the target terminal and the plurality of terminals may be the terminal device 11 in FIG. 1. For an example of the terminal device 11, refer to the foregoing descriptions. Details are not described herein again.

In this embodiment, the first network node performs step S501 to obtain the configuration information of the uplink resource of the target cell. Further, the first network node may obtain configuration information of uplink resources of a plurality of candidate cells, and then determine one cell from the plurality of candidate cells as the target cell. The candidate cell represents a cell to which the terminal may be handed over. During some implementations, in a case that the second network node and the first network node are two different network nodes/distributed units that belong to a same central network node/central unit, information exchanged between the first network node and the second network node is forwarded by the central network node/central unit. In a case that the second network node and the first network node are a same network node/distributed unit, the first network node and the second network node directly exchange information.

Further, in the case that the second network node and the first network node are two different network nodes/distributed units that belong to a same central network node/central unit, that the first network node obtains the configuration information of the uplink resource of the target cell is that the central network node/central unit obtains the configuration information of the uplink resource of the target cell from the second network node, and then the central network node/central unit forwards the configuration information to the first network node. The following steps are specifically included.

Step S501-1: The central network node sends a first interface message to the second network node, to request to obtain configuration information of at least one uplink resource of the target cell. In some implementations, the first interface message may be a UE context setup request (UE Context Setup Request) or a UE context modification request (UE Context Modification Request).

Step S501-2: The second network node returns a second interface message to the central network node, where the second interface message includes the configuration information of the at least one uplink resource of the target cell. In some implementations, the second interface message may be a UE context setup response (UE Context Setup Response) or a UE context modification response (UE Context Modification Response).

Step S501-3: The central network node sends a third interface message to the first network node, where the third interface message includes the configuration information of the at least one uplink resource allocated by the target cell. In some implementations, the third interface message may be a UE Context Modification Request.

Step S501-4: The first network node returns a fourth interface message to the central network node. In some implementations, the fourth interface message may be a UE Context Modification Response.

In some implementations, the uplink resource includes at least one of the following:
a CFRA resource;
a PUSCH resource;
a PUCCH resource;
an SRS resource; and
another uplink signal/channel resource.

During some implementations, the uplink resource obtained by the first network node may be the CFRA resource, and the CFRA resource represents a contention-free random access resource. The UE may obtain a timing advance TA value in advance by using the CFRA resource, which is specifically corresponding to Implementation 1 and Implementation 2 below; or may perform random access by using the CFRA resource, which is specifically corresponding to Implementation 3 and Implementation 4 below. The uplink resource may alternatively be the PUSCH resource, which is specifically corresponding to Implementation 5 below; or the Physical Uplink Control Channel (PUCCH) resource, which is specifically corresponding to Implementation 6 below. The terminal may send uplink data by using the foregoing uplink channel resource during RACH-less LTM handover, to notify the target cell of handover completion. In addition, the uplink resource may alternatively be the Sounding Reference Signal (SRS) or the another uplink signal/channel resource, which is not limited in this embodiment.

In some implementations, the configuration information of the uplink resource includes at least one of the following:
a configuration of the uplink resource;
identification information associated with the uplink resource; and
a radio network temporary identifier RNTI associated with the uplink resource.

In this embodiment, the configuration information of the uplink resource obtained by the first network node may be the specific configuration of the uplink resource, may be the identification information associated with the uplink resource, or may be the RNTI associated with the uplink resource. In some implementations, the first network node may directly obtain, based on the configuration of the uplink resource, the resource corresponding to the configuration. In addition, unique identification information may also be set for each uplink resource (or a configuration of the uplink resource), and a set of specific configuration parameters is represented by using the identification information, so that the first network node may determine the corresponding uplink resource based on the identification information to complete uplink resource configuration, which is specifically corresponding to Implementation 1 to Implementation 4 below. In some implementations, the first network node may further complete configuration of the uplink resource by obtaining the RNTI associated with the uplink resource, which is specifically corresponding to Implementation 5 and Implementation 6 below. In Implementation 5, in a case that the uplink resource is the PUSCH resource, a first common RNTI associated with the PUSCH resource may be obtained, to complete configuration of the PUSCH resource. In Implementation 6, in a case that the uplink resource is the PUCCH resource, a second common RNTI associated with the PUCCH resource may be obtained, to complete configuration of the PUCCH resource.

In this embodiment, the uplink resource is shared by the plurality of terminals served by the first network node. During some implementations, the resource may be shared by the plurality of terminals in a manner of protocol agreement, indicating that any one of the plurality of terminals can use the resource. It should be noted that a resource can be used by only one terminal at a same moment, and only after the terminal completes usage and releases the resource, the resource can be used by another terminal. In some implementations, the uplink resource is shared by a plurality of terminals in one cell served by the first network node, or shared by a plurality of terminals in a plurality of cells served by the first network node.

The first network node performs step S502 to send the first command, where the first command is used to allocate at least a part of the obtained uplink resource of the target cell for the target terminal in the plurality of terminals, and indicate the target terminal to obtain the timing advance TA value of the target cell based on the uplink resource or perform handover to the target cell based on the uplink resource, and the target cell belongs to the second network node. It may be understood that before sending the first command, the first network node needs to generate the first command. During some implementations, because the uplink resource is shared by the plurality of terminals, and the plurality of terminals cannot use a same uplink resource at the same time, it is proposed in this embodiment that the first network node generates the first command, and sends the first command to the target terminal, to indicate the target terminal to obtain the timing advance TA value of the target cell based on a specific uplink resource or perform handover to the target cell based on a specific uplink resource. The specific uplink resource indicated by the first command is the uplink resource of the target cell obtained in step S501 or a part of the uplink resource of the target cell. The first network node allocates the uplink resource for the target terminal by using the first command, indicating that the uplink resource is used by the target terminal. Correspondingly, the first network node stops allocation of the uplink resource for another terminal.

In some implementations, the sending a first command includes at least one of the following:

Step S502-1: Send a PDCCH order, where the PDCCH order is used to indicate the target terminal to initiate contention-free random access to the target cell based on the uplink resource.

Step S502-2: Send a cell handover command, where the cell handover command is used to indicate the target terminal to perform handover to the target cell based on the uplink resource.

During some implementations, the first command may have two types: the PDCCH order and the cell handover command. When the first command is the PDCCH order, the first network node sends the PDCCH order to the target terminal in the plurality of terminals, to indicate the target terminal to initiate contention-free random access to the target cell based on the uplink resource, which is specifically corresponding to Implementation 1 and Implementation 2 below. The PDCCH order includes an uplink resource, for example, a CFRA resource, allocated by the target cell. Correspondingly, after receiving the PDCCH order, the terminal sends, on a RACH occasion indicated by the PDCCH order, a preamble indicated by the PDCCH order. When the first command is the cell handover command, the first network node sends the cell handover command to the target terminal in the plurality of terminals, to indicate the target terminal to perform handover to the target cell based on the uplink resource, which is specifically corresponding to Implementation 3 to Implementation 6 below.

In some implementations, the cell handover command includes at least one of the following:
an index associated with a configuration of the target cell;
a Transmission Configuration Indicator (TCI) state of the target cell;
the PUSCH resource of the target cell;
identification information associated with the PUSCH resource of the target cell;
a common RNTI associated with the PUSCH resource of the target cell;
the PUCCH resource of the target cell;
identification information associated with the PUCCH resource of the target cell;
a common RNTI associated with the PUCCH resource of the target cell;
the TA value of the target cell; and
an indication of performing RACH-less handover in the target cell.

In some implementations, the central network node/central unit provides an RRC preconfiguration for the terminal. In some implementations, the RRC preconfiguration includes a configuration of one or more LTM candidate cells, a configuration of each candidate cell includes a common RACH configuration, and the common RACH configuration may be a RACH-ConfigCommon IE. Correspondingly, the terminal receives the RRC preconfiguration to complete corresponding configuration. The candidate cell is a cell to which the terminal may be handed over.

The target terminal determines, based on the RRC preconfiguration and the first command, whether the second network node and the first network node are a same network node, where the RRC preconfiguration includes a list of source cells that belong to a same network node as each target cell; and
if a source cell in which the target terminal is located is in a source cell list associated with the target cell indicated by the first command, determines that the second network node and the first network node are the same network node; or
if a source cell in which the target terminal is located is not in a source cell list associated with the target cell indicated by the first command, determines that the second network node and the first network node are different network nodes.

In a related technology, to perform LTM, the terminal needs to obtain in advance the Timing Advance value (TA value) of the target cell to which handover is to be performed, or send a handover complete indication to the target cell after handover to the target cell. However, to complete each of the foregoing two tasks, the target cell needs to allocate a corresponding resource for the terminal, for example, preconfigure, for the terminal, a CFRA resource used for obtaining the TA value, and a CG resource required for indicating handover completion to the target cell after a handover command is received. If the terminal is not handed over to the target cell for a long time after receiving the allocated resource, the resources reserved by the target cell for the terminal are wasted.

To resolve the foregoing problem, an embodiment of this application provides a resource configuration method. The method is applied to a first network node and includes: obtaining configuration information of an uplink resource of a target cell, where the uplink resource is shared by a plurality of terminals served by the first network node; and sending a first command, where the first command is used to allocate at least a part of the obtained uplink resource of the target cell for a target terminal in the plurality of terminals, and indicate the target terminal to obtain a timing advance TA value of the target cell based on the uplink resource or perform handover to the target cell based on the uplink resource, and the target cell belongs to a second network node. In this embodiment of this application, the configuration information of the uplink resource of the target cell is obtained, and the plurality of terminals share the uplink resource of the target cell, so that any one of the plurality of terminals can use the uplink resource, thereby implementing resource sharing, and avoiding a problem that a resource waste is caused because a terminal is not handed over for a long time after the terminal occupies the resource. In addition, in this embodiment of this application, the first network node sends the first command to indicate the target terminal in the plurality of terminals to obtain the timing advance TA value based on the uplink resource or perform cell handover based on the uplink resource (at least a part of the obtained uplink resource of the target cell) specified in the first command. In a case that the plurality of terminals share the uplink resource, the target terminal can be specified, by using the first command, to use the uplink resource, to implement uplink resource allocation.

In some implementations, after the first command is sent, at least one of the following is further included.

Step S503: Suspend allocation of the uplink resource for a terminal other than the target terminal in the plurality of terminals.

Step S504: In a case that information related to an uplink resource based on which the TA value is obtained is received or in a case that a notification message representing that cell handover is completed is received, continue to allocate the uplink resource for a terminal that needs to obtain the TA value or perform cell handover in the plurality of terminals.

During some implementations, because a resource can be used by only one terminal at a same moment, to avoid allocation of a same resource for the plurality of terminals at the same time, after the first network node sends the first command to indicate the target terminal to obtain the TA value based on the uplink resource or perform cell handover based on the uplink resource, the first network node suspends allocation of the uplink resource for another terminal, thereby avoiding a problem of a resource allocation error and improving stability of resource usage.

In a case that the target terminal obtains the TA value or completes cell handover based on the uplink resource, the target terminal has completed the task indicated by the first command, and no longer needs to use the uplink resource. Therefore, the target terminal releases the uplink resource. After receiving a corresponding message, the first network node may continue to allocate the uplink resource for another terminal in the plurality of terminals. The message received by the first network node mainly has two types: One type is information related to an uplink resource based on which the TA value is obtained, and is corresponding to Implementation 1 and Implementation 2 below, for example, first information or second information sent by the second network node. The other type is a notification message representing that cell handover is completed, and is corresponding to Implementation 3 to Implementation 6 below. For example, after determining that the target terminal has been handed over to the target cell, the central network node/central unit may send the notification message to the first network node. In this embodiment, when receiving a corresponding message, the first network node continues to allocate the uplink resource for another terminal that needs to obtain the TA value or perform cell handover, so that the another terminal obtains the TA value by using the uplink resource or performs cell handover by using the uplink resource, thereby avoiding a problem that a resource waste is caused because the target terminal continuously occupies the uplink resource. It should be known that different uplink resources, different first commands, and the like all lead to a specific difference in the resource configuration method provided in this embodiment of this application. The following implementations further describe the resource configuration method based on the foregoing embodiment.

### Implementation 1

In this implementation, in a case that the uplink resource is a CFRA resource, the first network node allocates the specific CFRA resource for the target terminal by using the first command (PDCCH order), to indicate the target terminal to perform early-RACH based on the CFRA resource, to obtain the TA value of the target cell. Herein, early-RACH indicates that the target cell allocates the CFRA resource for the terminal, and the target terminal performs RACH to the target cell before handover is initiated, to obtain the TA value of the target cell. Specific steps are as follows:

Step S600: The central network node provides an RRC preconfiguration for the terminal.

In some implementations, the RRC preconfiguration includes a configuration of one or more LTM candidate cells, a configuration of each candidate cell includes a common RACH configuration, and the common RACH configuration may be a RACH-ConfigCommon IE. Correspondingly, the terminal receives the RRC preconfiguration to complete corresponding configuration. The candidate cell is a cell to which the terminal may be handed over.

Step S601 is the same as step S501 in the foregoing embodiment.

In some implementations, the configuration information of the uplink resource obtained by the first network node is configuration information of the CFRA resource. In some implementations, the configuration information may be a configuration of the CFRA resource, or may be identification information associated with the CFRA resource.

In an embodiment, in a case that the uplink resource is the CFRA resource, the configuration information of the CFRA resource includes at least one of the following:
an SS/PBCH index;
a PRACH mask index; and
a random access preamble index.

In some implementations, a sequence between step S600 and step S601 may be interchanged.

Step S602 is the same as step S502-1 in the foregoing embodiment. In some implementations, the first network node sends a PDCCH order to the target terminal, where the PDCCH order is used to indicate the target terminal to initiate contention-free random access to the target cell based on the uplink resource. It may be understood that before sending the PDCCH order (first command), the first network node needs to first generate the PDCCH order (first command).

During some implementations, the first network node may obtain CFRA resources of a plurality of candidate cells in advance, and share the CFRA resources with a plurality of terminals. When the first network node needs to obtain a TA value corresponding to a terminal in the plurality of terminals, the terminal is set as the target terminal, the target cell is determined from the plurality of candidate cells, a CFRA resource is selected from a CFRA resource pool of the target cell and allocated for the target terminal, and a PDCCH order is sent to the target terminal, to indicate the target terminal to obtain the TA value of the target cell based on the selected CFRA resource. In some implementations, the PDCCH order includes one CFRA resource of the target cell. The PDCCH order may further include a random access preamble, that is, a preamble.

Correspondingly, step S602 further includes: Step S602-2: The target terminal receives the first command.

Step S602-3: The target terminal sends first uplink information based on the uplink resource, where the first uplink information is used to obtain the TA value.

In some implementations, after receiving the PDCCH order (first command) sent by the first network node, the terminal determines, by using the common RACH configuration received in step S600, a specific location of the CFRA resource indicated in the PDCCH order, to send the first uplink information to the second network node by using the CFRA resource. That is, the preamble indicated by the PDCCH order is sent to the second network node on a RACH occasion indicated by the PDCCH order.

In Implementation 1, the first uplink information may be a RACH Msg1, and step S603 includes:

Step S603-1: The second network node receives the RACH Msg1, and obtains the TA value based on the RACH Msg1.

In some implementations, the second network node receives the RACH Msg1 by using the CFRA resource, detects the preamble carried in the RACH Msg1, and obtains the corresponding TA value.

Step S603-2: The second network node sends first information, where the first information is information related to an uplink resource based on which the TA value is obtained.

During some implementations, in a case that the second network node and the first network node are two different network nodes/distributed units that belong to a same central network node/central unit, information exchanged between the first network node and the second network node is forwarded by the central network node/central unit. In a case that the second network node and the first network node are a same network node/distributed unit, the first network node and the second network node directly exchange information. Further, in the case that the second network node and the first network node are two different network nodes/distributed units that belong to a same central network node/central unit, step S603-2 includes:

Step S603-2-1: The second network node sends a fifth interface message to the central network node, where the fifth interface message includes the first information. In some implementations, the fifth interface message may be a UE context modification required (UE Context Modification Required).

Step S603-2-2: The central network node returns a sixth interface message to the second network node. In some implementations, the sixth interface message may be a UE Context Modification Confirm.

In some implementations, in a case that the fifth interface message is new (non-existing) F1 interface signaling, step S603-2-2 is omitted. In some implementations, when there is no existing F1 interface signaling between the second network node and the central network node, new F1 interface signaling needs to be sent to carry a message that needs to be transmitted, such as the first information. When the interface signaling is new F1 interface signaling, the central network node does not need to reply, that is, the central network node does not need to return the sixth interface message to the second network node.

Step S603-2-3: The central network node sends a seventh interface message to the first network node, where the seventh interface message includes the first information. In some implementations, the seventh interface message may be a UE Context Modification Request.

Step S603-2-4: The first network node returns an eighth interface message to the central network node. In some implementations, the eighth interface message may be a UE Context Modification Response.

In some implementations, in a case that the seventh interface message is new (non-existing) F1 interface signaling, step S603-2-4 is omitted. In some implementations, when there is no existing F1 interface signaling between the central network node and the first network node, new F1 interface signaling needs to be sent to carry a message that needs to be transmitted, such as the first information. When the interface signaling is new F1 interface signaling, the first network node does not need to reply, that is, the first network node does not need to return the eighth interface message to the central network node.

In some implementations, the first information includes at least one of the following:
the TA value of the target cell;
the configuration information of the uplink resource and/or identification information associated with the uplink resource;
identification information of the uplink resource; and
power control information for sending a PUSCH.

In Implementation 1, the first information may include the TA value of the target cell, the configuration information of the CFRA resource and/or identification information associated with the CFRA resource, identification information of the CFRA resource, and the power control information for sending a PUSCH.

In some implementations, step S603 further includes:

Step S603-3: The second network node sends a RACH Msg2 to the target terminal, where the RACH Msg2 includes at least the TA value of the target cell.

During some implementations, the RACH Msg2 includes at least the TA value of the target cell. In a case that the first network node and the second network node are different network nodes/distributed units, when solutions in both Implementation 1 and Implementation 4 are supported, the second network node cannot determine which solution is performed currently. Therefore, after the second network node performs step S603-1, that is, after the second network node receives the RACH Msg1, and obtains the TA value based on the RACH Msg1, not only step S603-2 needs to be performed to send the first information to the first network node according to the solution in Implementation 1, but also step S603-3 needs to be performed to send the RACH Msg2 to the target terminal according to the solution in Implementation 4. Because the first network node and the target terminal know whether Implementation 1 or Implementation 4 is performed currently, in a case that Implementation 1 is performed, the first network node continues to perform subsequent step S604; or in a case that Implementation 4 is performed, the target terminal performs subsequent step S904 in Implementation 4.

Step S604: The first network node receives the first information, where the first information is information related to an uplink resource based on which the TA value is obtained; and determines, based on the first information, that the TA value corresponds to the target terminal.

The second network node receives the RACH Msg1 by using the CFRA resource, detects the preamble carried in the RACH Msg1, and obtains the corresponding TA value. Because the CFRA resource is shared with the plurality of terminals served by the first network node, the second network node cannot determine, based on the RACH Msg1, which terminal the TA value specifically corresponds to. The second network node sends the first information to the first network node through the central network node, where the first information is information related to an uplink resource based on which the TA value is obtained. In step S602, the first network node sends the PDCCH order to the target terminal, so that the CFRA resource that needs to be used is indicated to the target terminal. Therefore, the first network node may determine, based on the first information (for example, the configuration information of the CFRA resource), that the TA value in the first information corresponds to the target terminal in the plurality of terminals. Therefore, Implementation 1 resolves a problem of how to determine, in a scenario in which the CFRA resource is shared with the plurality of terminals served by the first network node, which terminal in the plurality of terminals the TA value obtained by using the CFRA resource corresponds to.

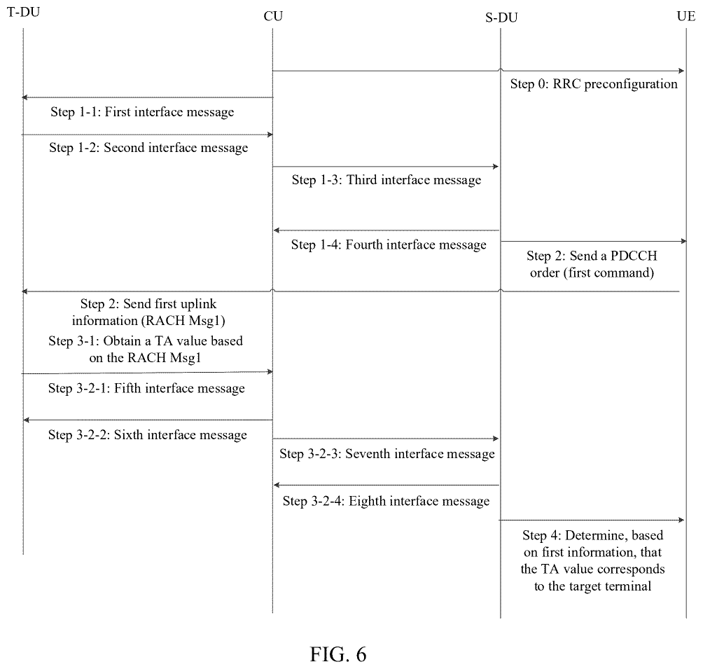

For example, FIG. 6 shows a process of obtaining the TA value based on the CFRA resource in Implementation 1 in a case that the first network node and the second network node are two different network nodes/distributed units that belong to a same central network node/central unit. As shown in FIG. 6, a plurality of interaction objects in Implementation 1 are a first network node S-DU, a second network node T-DU, a terminal UE, and a central network node/central unit CU. The following describes step 0 to step 4 in FIG. 6.
Step 0: The central network node/central unit provides an RRC preconfiguration for the terminal.
Step 1-1: The central network node/central unit sends a first interface message to the second network node, to request to obtain configuration information of at least one uplink resource of a target cell.
Step 1-2: The second network node returns a second interface message to the central network node/central unit, where the second interface message includes the configuration information of the at least one uplink resource of the target cell.
Step 1-3: The central network node/central unit sends a third interface message to the first network node, where the third interface message includes the configuration information of the at least one uplink resource allocated by the target cell.
Step 1-4: The first network node returns a fourth interface message to the central network node/central unit.
Step 2: The first network node sends a PDCCH order (first command) to the target terminal. The target terminal receives the PDCCH order. The target terminal sends first uplink information (such as a RACH Msg1) based on a CFRA resource specified in the PDCCH order, where the first uplink information is used to obtain a TA value.
Step 3-1: The second network node receives the RACH Msg1, and obtains the TA value based on the RACH Msg1.
Step 3-2-1: The second network node sends a fifth interface message to the central network node/central unit, where the fifth interface message includes first information.
Step 3-2-2: The central network node/central unit returns a sixth interface message to the second network node.
Step 3-2-3: The central network node/central unit sends a seventh interface message to the first network node, where the seventh interface message includes the first information.
Step 3-2-4. The first network node returns an eighth interface message to the central network node/central unit.
Step 4: The first network node receives the first information, where the first information is information related to an uplink resource based on which the TA value is obtained; and determines, based on the first information, that the TA value corresponds to the target terminal.

### Implementation 2

In this implementation, in a case that the uplink resource is a CFRA resource, the first network node allocates the specific CFRA resource for the target terminal by using the first command (PDCCH order), to indicate the target terminal to perform early-RACH based on the CFRA resource, to obtain the TA value of the target cell. Herein, early-RACH indicates that the target cell allocates the CFRA resource for the terminal, and the target terminal performs RACH to the target cell before handover is initiated, to obtain the TA value of the target cell. In addition, the first network node notifies the second network node of information about the specific CFRA resource, and the second network node determines, based on the information, the TA value and a terminal to which the TA value corresponds, and notifies the first network node of the TA value and the terminal. Specific steps are as follows:

Step S700 is the same as step S600 in Implementation 1.

Step S701 is the same as step S601 in Implementation 1.

Step S702 is the same as step S602 in Implementation 1.

Step S703: The first network node sends first notification information, where the first notification information includes identification information of the target terminal and the configuration information of the uplink resource and/or identification information of the configuration information of the uplink resource.

During some implementations, the first network node indicates, by using a PDCCH order in step S702, the target terminal to obtain the TA value of the target cell based on a specific CFRA resource, and sends the first notification information in step S703, to notify the second network node of the identification information of the target terminal, configuration information of the CFRA resource allocated for the target terminal, and/or identification information of the configuration information of the CFRA resource. In a case that the second network node and the first network node are two different network nodes/distributed units that belong to a same central network node/central unit, step S703 includes:

Step S703-1: The first network node sends a ninth interface message to the central network node/central unit, where the ninth interface message includes the first notification information. In some implementations, the ninth interface message may be a UE Context Modification Required.

Step S703-2: The central network node/central unit returns a tenth interface message to the first network node. In some implementations, the tenth interface message may be a UE Context Modification Confirm.

In some implementations, in a case that the ninth interface message is new (non-existing) F1 interface signaling, step S703-2 is omitted.

Step S703-3: The central network node/central unit sends an eleventh interface message to the second network node, where the eleventh interface message includes the first notification information. In some implementations, the eleventh interface message may be a UE Context Modification Request.

Step S703-4: The second network node returns a twelfth interface message to the central network node/central unit. In some implementations, the twelfth interface message may be a UE Context Modification Response.

In some implementations, in a case that the eleventh interface message is new (non-existing) F1 interface signaling, step S703-4 is omitted.

In some implementations, an execution sequence between step S702 and step S703 may be interchanged.

Step S704: The second network node receives the first notification information.

Step S705-1 is the same as step S603-1 in Implementation 1.

Step S705-2: The second network node determines, based on the first notification information, identification information of a terminal to which the TA value corresponds.

The second network node may learn, based on the first notification information, identification information of a terminal that uses the specific CFRA resource, so that the identification information of the terminal can be associated with the TA value. For example, the first network node indicates, by using the PDCCH order, the target terminal (the identification information of the target terminal is A) to obtain the TA value from the target cell based on the specific CFRA resource (the identification information of the configuration information of the CFRA resource is 001), and sends the first notification information (including the identification information A of the target terminal and the identification information 001 of the configuration information of the CFRA resource) to the target cell. The target cell detects a preamble on the CFRA resource 001, detects that the TA value is 0.001s, and may determine, based on the first notification information, that the TA value 0.001s corresponds to the terminal whose terminal identification information is A.

Step S706: The second network node sends second information, where the second information is information related to an identifier of the terminal to which the TA value corresponds.

During some implementations, after determining the TA value and the identification information of the terminal to which the TA value corresponds, the second network node generates the second information and sends the second information to the first network node. In a case that the second network node and the first network node are two different network nodes/distributed units that belong to a same central network node/central unit, step S706 includes:

Step S706-1: The second network node sends a thirteenth interface message to the central network node/central unit, where the thirteenth interface message includes the second information. In some implementations, the thirteenth interface message may be a UE Context Modification Required.

Step S706-2: The central network node/central unit returns a fourteenth interface message to the second network node. In some implementations, the fourteenth interface message may be a UE Context Modification Confirm.

In some implementations, in a case that the thirteenth interface message is new (non-existing) F1 interface signaling, step S706-2 is omitted.

Step S706-3: The central network node/central unit sends a fifteenth interface message to the first network node, where the fifteenth interface message includes the second information. In some implementations, the fifteenth interface message may be a UE Context Modification Request.

Step S706-4: The first network node returns a sixteenth interface message to the central network node/central unit. In some implementations, the sixteenth interface message may be a UE Context Modification Response.

In some implementations, in a case that the fifteenth interface message is new (non-existing) F1 interface signaling, step S706-4 is omitted.

In some implementations, the second information includes at least one of the following: the TA value of the target cell;
the identification information of the target terminal; and
power control information for sending a PUSCH.

Step S707: The first network node receives the second information, and determines, based on the second information, that the TA value corresponds to the target terminal.

The second network node receives the RACH Msg1 by using the CFRA resource, detects the preamble carried in the RACH Msg1, and obtains the corresponding TA value. Because the CFRA resource is shared with the plurality of terminals served by the first network node, the second network node cannot directly determine, based on the RACH Msg1, which terminal the TA value specifically corresponds to. In Implementation 2, the first network node sends the first notification information to the second network node in step S703, to notify the second network node of the identification information of the terminal that uses the CFRA resource and the corresponding configuration information of the CFRA resource and/or the identification information of the configuration information of the uplink resource. In this way, the second network node may determine, based on the first notification information, the identification information of the terminal to which the TA value corresponds. Then, the second network node sends, to the first network node through the central network node/central unit, the second information that carries the TA value and the identification information of the terminal, so that the first network node may determine, based on the second information, that the TA value corresponds to the target terminal in the plurality of terminals. Therefore, Implementation 2 resolves a problem of how to determine, in a scenario in which the CFRA resource is shared with the plurality of terminals served by the first network node, which terminal in the plurality of terminals the TA value obtained by using the CFRA resource corresponds to.

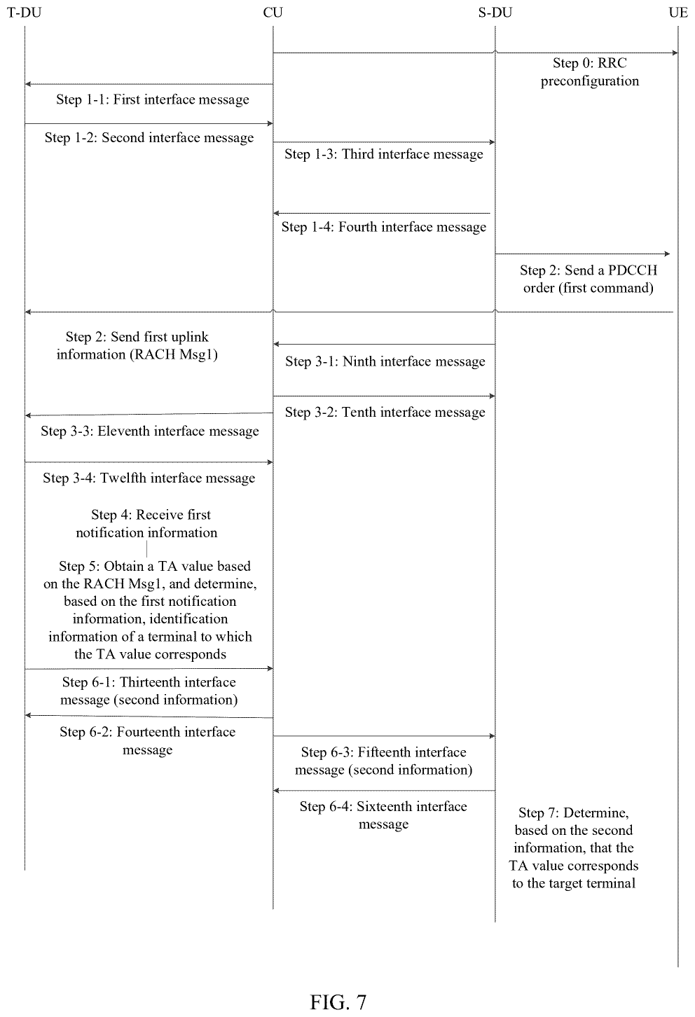

For example, FIG. 7 shows a process of obtaining the TA value based on the CFRA resource in Implementation 2 in a case that the first network node and the second network node are two different network nodes/distributed units that belong to a same central network node/central unit. As shown in FIG. 7, a plurality of interaction objects in Implementation 2 are a first network node S-DU, a second network node T-DU, a terminal UE, and a central network node/central unit CU. The following describes step 0 to step 7 in FIG. 7.
Step 0: The central network node/central unit provides an RRC preconfiguration for the terminal.
Step 1-1: The central network node/central unit sends a first interface message to the second network node, to request to obtain configuration information of at least one uplink resource of a target cell.
Step 1-2: The second network node returns a second interface message to the central network node/central unit, where the second interface message includes the configuration information of the at least one uplink resource of the target cell.
Step 1-3: The central network node/central unit sends a third interface message to the first network node, where the third interface message includes the configuration information of the at least one uplink resource allocated by the target cell.
Step 1-4: The first network node returns a fourth interface message to the central network node/central unit.
Step 2: The first network node sends a PDCCH order (first command) to the target terminal. The target terminal receives the PDCCH order. The target terminal sends first uplink information (RACH Msg1) based on a CFRA resource specified in the PDCCH order, where the first uplink information is used to obtain a TA value.
Step 3-1: The first network node sends a ninth interface message to the central network node/central unit, where the ninth interface message includes first notification information, and the first notification information includes identification information of the target terminal and the configuration information of the uplink resource and/or identification information of the configuration information of the uplink resource.
Step 3-2: The central network node/central unit returns a tenth interface message to the first network node.
Step 3-3: The central network node/central unit sends an eleventh interface message to the second network node, where the eleventh interface message includes the first notification information.
Step 3-4: The second network node returns a twelfth interface message to the central network node/central unit.
Step 4: The second network node receives the first notification information.
Step 5: The second network node receives the RACH Msg1, obtains the TA value based on the RACH Msg1, and determines, based on the first notification information, identification information of a terminal to which the TA value corresponds.
Step 6-1: The second network node sends a thirteenth interface message to the central network node/central unit, where the thirteenth interface message includes second information.
Step 6-2: The central network node/central unit returns a fourteenth interface message to the second network node.
Step 6-3: The central network node/central unit sends a fifteenth interface message to the first network node, where the fifteenth interface message includes the second information.
Step 6-4: The first network node returns a sixteenth interface message to the central network node/central unit.
Step 7: The first network node receives the second information, and determines, based on the second information, that the TA value corresponds to the target terminal.

### Implementation 3

In this implementation, in a case that the uplink resource is a CFRA resource, the first network node allocates the specific CFRA resource for the target terminal by using the first command (cell handover command), to indicate the target terminal to perform random access based on the CFRA resource, to hand over to the target cell. Specific steps are as follows:

Step S800 is the same as step S600 in Implementation 1.

Step S801 is the same as step S601 in Implementation 1.

Step S802 is the same as step S502-2 in the foregoing embodiment, that is, the first network node sends a cell handover command, where the cell handover command is used to indicate the target terminal to perform handover to the target cell based on the uplink resource.

During some implementations, the first network node may obtain CFRA resources of a plurality of candidate cells in advance, and share the CFRA resources with a plurality of terminals. When the first network node needs handover of a terminal in the plurality of terminals, the terminal is set as the target terminal, the target cell is determined from the plurality of candidate cells, a CFRA resource is selected from a CFRA resource pool of the target cell and allocated for the target terminal, and a cell handover command is sent to the target terminal, to indicate the target terminal to perform handover to the target cell/a target cell group based on the selected CFRA resource. In Implementation 3, in a case that the uplink resource is a CFRA resource, the cell handover command may include a CFRA resource of the target cell, and may further include a random access preamble, that is, a preamble.

Correspondingly, step S802 further includes step S802-2: The target terminal receives the first command.

Step S802-3: The target terminal sends first uplink information based on the uplink resource, where the first uplink information is used to perform cell handover.

In some implementations, after receiving the cell handover command (first command) sent by the first network node, the terminal determines, by using the common RACH configuration received in step S800, a specific location of the CFRA resource indicated in the cell handover command, to send the first uplink information to the second network node by using the CFRA resource. In Implementation 3, the first uplink information may be a RACH Msg1.

Step S803 is the same as step S703 in Implementation 2, that is, the first network node sends first notification information, where the first notification information includes identification information of the target terminal and the configuration information of the uplink resource and/or identification information of the configuration information of the uplink resource.

In some implementations, step S803 may be performed after step S802, or may be performed after an ACK message of the cell handover command sent in step S802 is received. Step S804 is the same as step S704 in Implementation 2.

Step S805-1 is the same as step S705-1 in Implementation 2.

Step S805-2: The second network node determines, based on the first notification information, identification information of a terminal that performs cell handover based on the uplink resource.

The second network node may learn, based on the first notification information, identification information of a terminal that uses the specific CFRA resource, so that the identification information of the terminal can be associated with the TA value. For example, the first network node indicates, by using the cell handover command, the target terminal (the identification information of the target terminal is B) to perform handover to the target cell based on the specific CFRA resource (the identification information of the configuration information of the CFRA resource is 002), and sends the first notification information (the identification information B of the target terminal and the identification information 002 of the configuration information of the CFRA resource) to the target cell. The target cell detects a preamble on the CFRA resource 002, detects that the TA value is 0.002s, and may determine, based on the first notification information, that the TA value 0.002s corresponds to the terminal whose terminal identification information is B, that is, the identification information of the terminal that performs cell handover is B.

Step S806: The second network node sends a RACH Msg2 to the target terminal.

In some implementations, the RACH Msg2 includes the TA value of the target cell, and the second network node notifies the target terminal of a random access success by using the RACH Msg2. In this embodiment, after receiving the RACH Msg2, the target terminal releases the CFRA resource indicated by the cell handover command.

According to steps S800 to S806, it can be learned that Implementation 3 includes: The target terminal sends the RACH Msg1 to the second network node based on the allocated CFRA resource according to an indication of the cell handover command. The second network node receives the RACH Msg1 by using the CFRA resource, detects the preamble carried in the RACH Msg1, and obtains the corresponding TA value. Because the CFRA resource is shared with the plurality of terminals served by the first network node, the second network node cannot directly determine, based on the RACH Msg1, which terminal the TA value specifically corresponds to. In Implementation 3, the first network node sends the first notification information to the second network node in step S803, to notify the second network node of the identification information of the terminal that uses the CFRA resource and the corresponding configuration information of the CFRA resource and/or the identification information of the configuration information of the uplink resource. In this way, the second network node may determine, based on the first notification information, the identification information of the terminal to which the TA value corresponds, that is, the identification information of the terminal that initiates handover. Then, the second network node sends the RACH Msg2 to the target terminal, to notify the target terminal of the random access success. Therefore, Implementation 3 resolves a problem of how to determine, in a scenario in which the CFRA resource is shared with the plurality of terminals served by the first network node, which terminal in the plurality of terminals is the terminal that performs random access by using the CFRA resource.

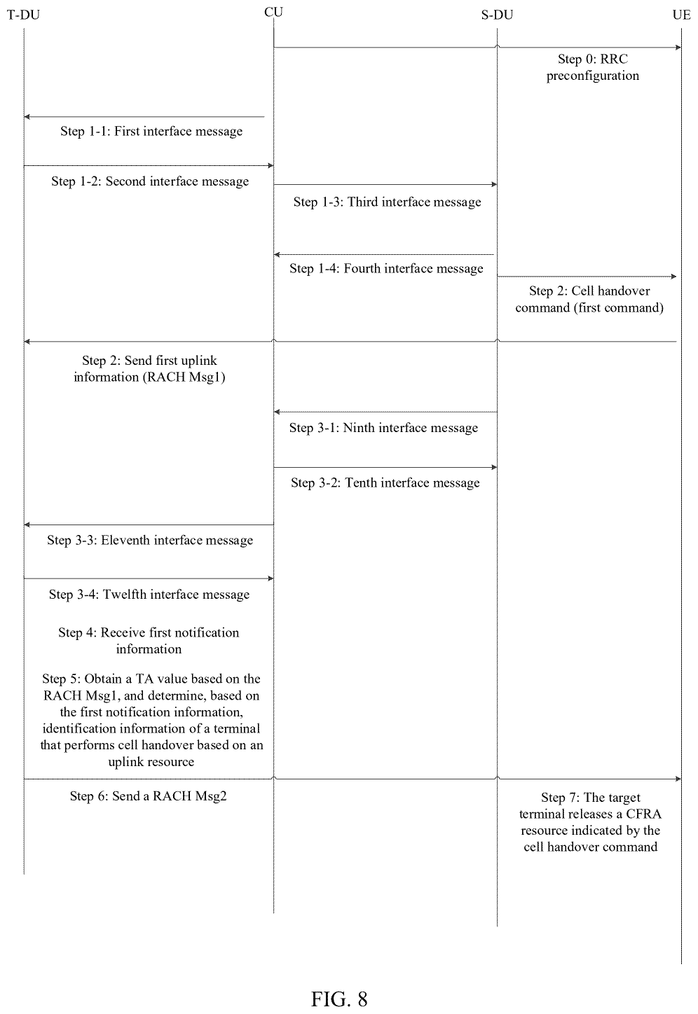

For example, FIG. 8 shows a process of performing random access based on the CFRA resource in Implementation 3 in a case that the first network node and the second network node are two different network nodes/distributed units that belong to a same central network node/central unit. As shown in FIG. 8, a plurality of interaction objects in Implementation 3 are a first network node S-DU, a second network node T-DU, a terminal UE, and a central network node/central unit CU. The following describes step 0 to step 7 in FIG. 8.
Step 0: The central network node/central unit provides an RRC preconfiguration for the terminal.
Step 1-1: The central network node/central unit sends a first interface message to the second network node, to request to obtain configuration information of at least one uplink resource of a target cell.
Step 1-2: The second network node returns a second interface message to the central network node/central unit, where the second interface message includes the configuration information of the at least one uplink resource of the target cell.
Step 1-3: The central network node/central unit sends a third interface message to the first network node, where the third interface message includes the configuration information of the at least one uplink resource allocated by the target cell.
Step 1-4: The first network node returns a fourth interface message to the central network node/central unit.
Step 2: The first network node sends a cell handover command (first command) to the target terminal. The target terminal receives the cell handover command. The target terminal sends first uplink information (RACH Msg1) based on a CFRA resource specified in the cell handover command, where the first uplink information is used to perform cell handover.
Step 3-1: The first network node sends a ninth interface message to the central network node/central unit, where the ninth interface message includes first notification information, and the first notification information includes identification information of the target terminal and the configuration information of the uplink resource and/or identification information of the configuration information of the uplink resource.
Step 3-2: The central network node/central unit returns a tenth interface message to the first network node.
Step 3-3: The central network node/central unit sends an eleventh interface message to the second network node, where the eleventh interface message includes the first notification information.
Step 3-4: The second network node returns a twelfth interface message to the central network node/central unit.
Step 4: The second network node receives the first notification information.
Step 5: The second network node receives the RACH Msg1, obtains the TA value based on the RACH Msg1, and determines, based on the first notification information, identification information of a terminal that performs cell handover based on the uplink resource.
Step 6: The second network node sends a RACH Msg2 to the target terminal.
Step 7: After receiving the RACH Msg2, release the CFRA resource indicated by the cell handover command.

### Implementation 4

In this implementation, in a case that the uplink resource is a CFRA resource, the first network node allocates the specific CFRA resource for the target terminal by using the first command (cell handover command), to indicate the target terminal to perform random access based on the CFRA resource, to hand over to the target cell. Specific steps are as follows:

Step S900 is the same as step S600 in Implementation 1.

Step S901 is the same as step S601 in Implementation 1.

Step S902 is the same as step S802 in Implementation 3.

Step S903 includes:

Step S903-1 is the same as step S603-1 in Implementation 1, that is, the second network node receives the RACH Msg1, and obtains the TA value based on the RACH Msg1.

In some implementations, the second network node receives, by using the CFRA resource, the RACH Msg1 (first uplink information) sent by the target terminal, detects the preamble carried in the RACH Msg1, and obtains the corresponding TA value.

Step S903-2 is the same as step S806 in Implementation 3, that is, the second network node sends, to the target terminal, a RACH Msg2, where the RACH Msg2 includes the TA value of the target cell.

In some implementations, step S903 further includes:

Step S903-3 is the same as step S603-2 in Implementation 1, that is, the second network node sends the first information to the first network node.

In a case that the first network node and the second network node are different network nodes/distributed units, when solutions in both Implementation 1 and Implementation 4 are supported, the second network node cannot determine which solution is performed currently. Therefore, after the second network node performs step S903-1, that is, after the second network node receives the RACH Msg1, and obtains the TA value based on the RACH Msg1, not only step S903-2 needs to be performed to send the RACH Msg2 to the target terminal according to the solution in Implementation 4, but also step S603-2 needs to be performed to send the first information to the first network node according to the solution in Implementation 1. Because the first network node and the target terminal know whether Implementation 1 or Implementation 4 is performed currently, in a case that Implementation 1 is performed, the first network node continues to perform subsequent step S604; or in a case that Implementation 4 is performed, the target terminal performs subsequent step S904 in Implementation 4.

In a case that the first network node and the second network node are a same network node/distributed unit, the second network node may determine, based on the cell handover command in step S902, that the target terminal initiates handover by using the CFRA resource. Therefore, in step S903-2, the second network node may directly determine that the terminal that performs cell handover is the target terminal, and the second network node directly notifies the target terminal of random access completion by sending the RACH Msg2, without performing subsequent steps.

In a case that the first network node and the second network node are different network nodes/distributed units, the second network node cannot identify an access terminal based on the received RACH Msg1. Therefore, subsequent steps further need to be performed.

Step S904: After receiving the RACH Msg2, the target terminal sends a RACH Msg3, where the RACH Msg3 includes information used to carry an identifier of the target terminal.

In some implementations, the information about the identifier of the target terminal may be a C-RNTI MAC CE. The identifier of the target terminal may be a private identifier allocated by a network side device for the target terminal. Based on the identifier, the target terminal can be distinguished from another terminal.

Step S905: The second network node determines, based on the RACH Msg3, the terminal that performs cell handover.

Step S906: The second network node sends a RACH Msg4, where the RACH Msg4 is scrambled by a target RNTI, the RACH Msg4 includes an uplink grant for scheduling new transmission, and the target RNTI is a C-RNTI allocated by the target cell for the terminal that performs cell handover.

During some implementations, the second network node may scramble the RACH Msg3 by using the C-RNTI MAC CE, to prevent another terminal from receiving the RACH Msg4, and send the RACH Msg4 to the target terminal, so as to notify the target terminal of access completion. After receiving the RACH Msg4, the target terminal releases the CFRA resource indicated by the cell handover command. For specific content of the RACH Msg3 and the RACH Msg4, refer to a RACH Msg3 and a RACH Msg4 in a CBRA procedure.

In a case that the first network node and the second network node are different network nodes/distributed units, the second network node cannot identify an access terminal based on the received RACH Msg1. Implementation 4 proposes that the target terminal sends, to the second network node, the RACH Msg3 that carries the identification information of the target terminal, so that the second network node scrambles the RACH Msg4 by using the identification information of the target terminal (the identification information of the target terminal is a target RNTI, indicating a C-RNTI allocated by the target cell for the terminal that performs cell handover), thereby ensuring that only the target terminal can descramble the RACH Msg4 to complete random access. Therefore, Implementation 4 resolves a problem of how to determine, in a scenario in which the CFRA resource is shared with the plurality of terminals served by the first network node, which terminal in the plurality of terminals is the terminal that performs random access by using the CFRA resource.

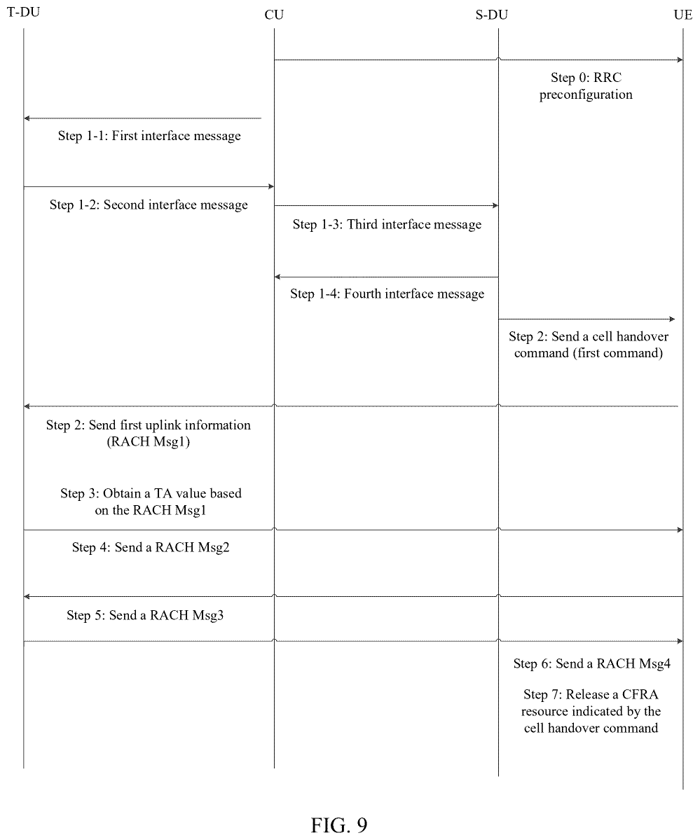

For example, FIG. 9 shows a process of performing random access based on the CFRA resource in Implementation 4 in a case that the first network node and the second network node are two different network nodes/distributed units that belong to a same central network node/central unit. As shown in FIG. 9, a plurality of interaction objects in Implementation 4 are a first network node S-DU, a second network node T-DU, a terminal UE, and a central network node/central unit CU. The following describes step 0 to step 7 in FIG. 9.
Step 0: The central network node/central unit provides an RRC preconfiguration for the terminal.
Step 1-1: The central network node/central unit sends a first interface message to the second network node, to request to obtain configuration information of at least one uplink resource of a target cell.
Step 1-2: The second network node returns a second interface message to the central unit, where the second interface message includes the configuration information of the at least one uplink resource of the target cell.
Step 1-3: The central network node/central unit sends a third interface message to the first network node, where the third interface message includes the configuration information of the at least one uplink resource allocated by the target cell.
Step 1-4: The first network node returns a fourth interface message to the central network node/central unit.
Step 2: The first network node sends a cell handover command (first command) to the target terminal. The target terminal receives the cell handover command. The target terminal sends first uplink information (RACH Msg1) based on a CFRA resource specified in the cell handover command, where the first uplink information is used to perform cell handover.
Step 3: The second network node receives the RACH Msg1, and obtains the TA value based on the RACH Msg1.
Step 4: The second network node sends a RACH Msg2 to the target terminal, where the RACH Msg2 includes the TA value of the target cell.
Step 5: After receiving the RACH Msg2, the target terminal sends a RACH Msg3, where the RACH Msg3 includes information used to carry an identifier of the target terminal.
Step 6: The second network node sends a RACH Msg4, where the RACH Msg4 is scrambled by a target RNTI, the RACH Msg4 includes an uplink grant for scheduling new transmission, and the target RNTI is a C-RNTI allocated by the target cell for the terminal that performs cell handover.
Step 7: After receiving the RACH Msg4, the target terminal releases the CFR A resource indicated by the cell handover command.

### Implementation 5

In this implementation, in a case that the uplink resource is a PUSCH resource, the first network node allocates the specific PUSCH resource for the target terminal by using the first command (cell handover command), to indicate the target terminal to perform RACH-less based on the PUSCH resource, to hand over to the target cell. Herein, RACH-less means that the target cell allocates an uplink resource for the target terminal in a dynamic scheduling or CG scheduling manner, so that the target terminal transmits a handover complete indication on the corresponding resource. Specific steps are as follows:

Step S1000: The central network node/central unit provides an RRC preconfiguration for the terminal.

In some implementations, the RRC preconfiguration includes a configuration of one or more LTM candidate cells, a configuration of each candidate cell includes third information, and the third information includes at least one of the following:
a PUSCH resource configuration of the target cell;
identification information associated with the PUSCH resource configuration of the target cell; and
a common RNTI associated with the PUSCH resource configuration of the target cell.

The PUSCH resource configuration may be a CG resource configuration, for example, a configuration provided by a ConfiguredGrantConfig 1E, or may be a newly defined PUSCH resource configuration that is periodic or takes effect in a period of time, and the PUSCH resource can be used only after being activated by using a MAC CE or DCI. The common RNTI is used for scrambling by any terminal that transmits data on the corresponding PUSCH resource.

Correspondingly, the terminal receives the RRC preconfiguration to complete corresponding configuration. The candidate cell is a cell to which the terminal may be handed over.

Step S1001 is the same as step S501 in the foregoing embodiment, that is, obtaining configuration information of an uplink resource of a target cell, where the uplink resource is shared by a plurality of terminals served by the first network node.

In some implementations, the configuration information of the uplink resource obtained by the first network node is configuration information of the PUSCH resource, and the configuration information includes the foregoing third information.

In a case that the second network node and the first network node are two different network nodes that belong to a same central network node/central unit, that the first network node obtains the configuration information of the uplink resource of the target cell is that the central network node/central unit obtains the configuration information of the uplink resource of the target cell from the second network node, and then the central network node/central unit forwards the configuration information to the first network node. The following steps are specifically included.

Step S1001-1: The central network node/central unit sends a twenty-first interface message to the second network node, to request to obtain configuration information of at least one PUSCH resource of a candidate cell. In some implementations, the twenty-first interface message may be a UE Context Setup Request or a UE Context Modification Request.

Step S1001-2: The second network node returns a twenty-second interface message to the central network node/central unit, where the twenty-second interface message includes third information. In some implementations, the twenty-second interface message may be a UE Context Setup Response or a UE Context Modification Response.

Step S1001-3: The central unit sends a twenty-third interface message to the first network node, where the twenty-third interface message includes the third information. In some implementations, the twenty-third interface message may be a UE Context Modification Request.

Step S1001-4: The first network node returns a twenty-fourth interface message to the central network node/central unit. In some implementations, the twenty-fourth interface message may be a UE Context Modification Response.

The PUSCH resource is shared by a plurality of terminals in one cell served by the first network node, or shared by a plurality of terminals in a plurality of cells served by the first network node.

In some implementations, a sequence between step S1000 and step S1001 may be interchanged.

Step S1002 is the same as step S502-2 in the foregoing embodiment, that is, the first network node sends a cell handover command to the target terminal, where the cell handover command is used to indicate the target terminal to perform handover to the target cell based on the uplink resource.

During some implementations, the first network node may obtain PUSCH resources of a plurality of candidate cells in advance, and share the PUSCH resources with a plurality of terminals. When the first network node needs to indicate a terminal in the plurality of terminals to perform cell handover, the terminal is set as the target terminal, the target cell is determined from the plurality of candidate cells, a PUSCH resource is selected from a PUSCH resource pool of the target cell and allocated for the target terminal, and a cell handover command is sent to the target terminal, to indicate the target terminal to perform handover to the target cell/a target cell group based on the selected PUSCH resource. In this case, the first network node suspends allocation of the selected PUSCH resource for another terminal.

In some implementations, in a case that the uplink resource is the PUSCH resource, the cell handover command includes at least one of the following:
an index associated with a configuration of the target cell;
a TCI state of the target cell;
the PUSCH resource of the target cell;
identification information associated with the PUSCH resource of the target cell;
a common RNTI associated with the PUSCH resource of the target cell; and
an indication of performing RACH-less handover in the target cell.

During some implementations, information that already exists in the RRC preconfiguration in step S1000 does not need to be repeatedly sent in the cell handover command in step S1002. For example, if the RRC preconfiguration in step S1000 includes an RNTI associated with an uplink resource configuration of the target cell, in step S1002, the RNTI associated with the uplink resource configuration of the target cell does not need to be sent in the cell handover command. Correspondingly, step S1002 further includes:

Step S1002-2: The target terminal receives a first command.

Step S1002-3: The target terminal sends first uplink information to the second network node based on the uplink resource, where the first uplink information is used to perform cell handover.

In Implementation 5, the first uplink information is PUSCH information transmitted based on the PUSCH resource and scrambled by a first common RNTI, where the first common RNTI is a common RNTI associated with the PUSCH resource. In some implementations, after receiving the cell handover command (first command) sent by the first network node, the target terminal determines, by using the RRC preconfiguration received in step S1000, a specific location of the PUSCH resource indicated in the cell handover command, and further sends, to the second network node based on the PUSCH resource indicated in the cell handover command, the PUSCH information scrambled by the first common RNTI.

Step S1003: The second network node receives the first uplink information, where the first uplink information is information used by the target terminal in the plurality of terminals to perform cell handover.

In some implementations, the second network node receives the PUSCH information scrambled by the first common RNTI, and the scrambled PUSCH information carries information about an identifier of a terminal that performs cell handover.

Step S1004: The second network node descrambles the PUSCH information on the PUSCH resource based on the first common RNTI, to obtain the information used to carry the identifier of the terminal that performs cell handover.

Step S1005: Determine, based on the information used to carry the identifier of the terminal that performs cell handover, the terminal that performs cell handover.

In some implementations, the information about the identifier is a C-RNTI MAC CE, and the second network node determines, based on the C-RNTI MAC CE, the terminal that performs cell handover.

After the target terminal completes the cell handover operation, the following steps are further included.

Step S1006: The second network node notifies the first network node that the target terminal completes cell handover.

During some implementations, in a case that the second network node and the first network node are two different network nodes that belong to a same central network node/central unit, the central network node/central unit forwards, to the first network node, a cell handover complete notification sent by the second network node. In a case that the second network node and the first network node are a same network node/distributed unit, the second network node directly sends a cell handover complete notification to the first network node.

Step S1007 is the same as step S504 in the foregoing embodiment, that is, when cell handover is completed, the first network node continues to allocate the uplink resource for a terminal that performs cell handover in the plurality of terminals.

During some implementations, after performing cell handover, the target terminal no longer needs to use the PUSCH resource. Therefore, the first network node may continue to allocate the PUSCH resource for another terminal in the plurality of terminals, so that the another terminal performs cell handover by using the PUSCH resource.

Step S1008: The second network node sends first PDCCH information to the target terminal, where the first PDCCH information is scrambled by an RNTI associated with information used to carry an identifier of the target terminal, and the first PDCCH information represents that the target terminal completes cell handover.

Correspondingly, after receiving the first PDCCH information, the target terminal releases the PUSCH resource indicated in the cell handover command in step S1002. In some implementations, after completing cell handover, the target terminal may directly release the PUSCH resource indicated in the cell handover command in step S1002.

In this implementation, the plurality of terminals served by the first network node share a PUSCH resource pool allocated by a same candidate cell. When the first network node indicates, by using the cell handover command, the target terminal to perform handover to the target cell, when performing cell handover (RACH-less handover), the target terminal sends the first uplink information (scrambled PUSCH information) based on the PUSCH resource indicated in the handover command, to notify the second network node that cell handover is completed. When different terminals send first uplink information on the shared PUSCH resource, scrambling is performed by using a same RNTI, and identification information of the target terminal is carried, so that the second network node identifies, based on the scrambled PUSCH information, the terminal that performs cell handover. Therefore, Implementation 5 resolves how to determine the terminal that performs cell handover and how to release the shared PUSCH resource after cell handover is completed in a scenario in which the PUSCH resource is shared with the plurality of terminals served by the first network node.

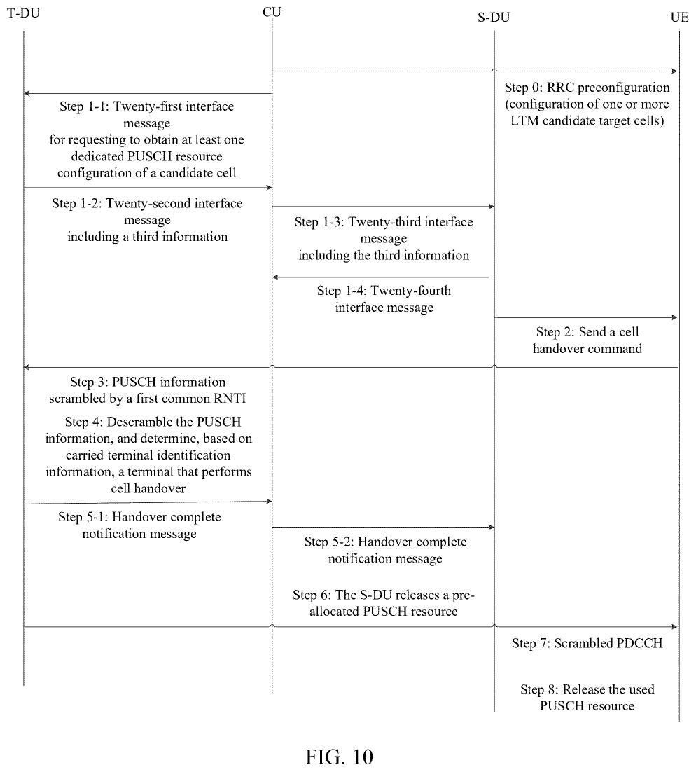

For example, FIG. 10 shows a process of performing cell handover based on the PUSCH resource in Implementation 5 in a case that the first network node and the second network node are two different network nodes that belong to a same central network node/central unit. As shown in FIG. 10, a plurality of interaction objects in Implementation 5 are a first network node S-DU, a second network node T-DU, a terminal UE, and a central network node/central unit CU. The following describes step 0 to step 8 in FIG. 10.
Step 0: The central network node/central unit provides an RRC preconfiguration for the terminal. In some implementations, the RRC preconfiguration includes a configuration of one or more LTM candidate cells. A configuration of each candidate cell includes third information, and the third information may include information such as at least one PUSCH resource configuration allocated by the candidate cell for a terminal, identification information associated with each PUSCH resource configuration, and a common RNTI associated with each PUSCH resource configuration.
Step 1-1: The central network node/central unit sends a twenty-first interface message to the second network node, to request to obtain at least one PUSCH resource configuration of a candidate cell.
Step 1-2: The second network node returns a twenty-second interface message to the terminal, where the message includes the third information, so that the central network node/central unit obtains the at least one PUSCH resource configuration of the candidate cell from the second network node.
Step 1-3: The central network node/central unit sends a twenty-third interface message to the first network node.
Step 1-4: The first network node returns a twenty-fourth interface message to the central network node/central unit, to send the at least one PUSCH resource configuration of the candidate cell obtained from the second network node to the first network node.
Step 2: The first network node sends a cell handover command to the target terminal, to indicate the target terminal to perform handover to the target cell based on a PUSCH resource in the handover command.
Step 3: The target terminal sends, to the second network node by using the PUSCH resource in the handover command, PUSCH information scrambled by a first common RNTI (that is, a common RNTI associated with the PUSCH resource).
Step 4: After receiving the scrambled PUSCH information, the second network node descrambles the PUSCH information by using the RNTI associated with the PUSCH resource, and identifies, based on terminal identification information carried in the PUSCH information, a terminal that performs cell handover.
Step 5-1: After determining that the terminal completes cell handover, the second network node sends a handover complete notification message to the central network node/central unit.
Step 5-2: The central network node/central unit sends the handover complete notification message to the first network node.
Step 6: After receiving the handover complete notification message, the first network node releases the pre-allocated PUSCH resource, that is, the first network node may continue to allocate the PUSCH resource for another terminal, so that the another terminal performs cell handover by using the PUSCH resource.
Step 7: The second network node sends scrambled PDCCH information to the terminal, so that the terminal releases, after receiving the PDCCH, the PUSCH resource indicated by the handover command.
Step 8: The terminal releases the PUSCH resource indicated by the handover command.

### Implementation 6

In this implementation, in a case that the uplink resource is a PUCCH resource, the first network node allocates the specific PUCCH resource for the target terminal by using the first command (cell handover command), to indicate the target terminal to perform RACH-less based on the PUCCH resource, to hand over to the target cell. Herein, RACH-less means that the target cell allocates an uplink resource for the target terminal in a dynamic scheduling or CG scheduling manner, so that the target terminal transmits a handover complete indication on the corresponding resource. Specific steps are as follows:

Step S1100: The central network node/central unit provides an RRC preconfiguration for the terminal.

In some implementations, the RRC preconfiguration includes a configuration of one or more LTM candidate cells, and a configuration of each candidate cell includes fourth information. In some implementations, the fourth information includes at least one of the following:
a PUCCH resource configuration of the target cell;
identification information associated with the PUCCH resource configuration of the target cell; and
a common RNTI associated with the PUCCH resource configuration of the target cell.

Correspondingly, the terminal receives the RRC preconfiguration to complete corresponding configuration. The candidate cell is a cell to which the terminal may be handed over.

Step S1101 is the same as step S501 in the foregoing embodiment, that is, obtaining configuration information of an uplink resource of a target cell, where the uplink resource is shared by a plurality of terminals served by the first network node.

In some implementations, the configuration information of the uplink resource obtained by the first network node is configuration information of the PUCCH resource, and the configuration information includes the foregoing fourth information.

In a case that the second network node and the first network node are two different network nodes that belong to a same central network node/central unit, that the first network node obtains the configuration information of the uplink resource of the target cell is that the central network node/central unit obtains the configuration information of the uplink resource of the target cell from the second network node, and then the central network node/central unit forwards the configuration information to the first network node. The following steps are specifically included.

Step S1101-1: The central network node/central unit sends a twenty-fifth interface message to the second network node, to request to obtain configuration information of at least one PUCCH resource of a candidate cell. In some implementations, the twenty-fifth interface message may be a UE Context Setup Request or a UE Context Modification Request.

Step S1101-2: The second network node returns a twenty-sixth interface message to the central network node/central unit, where the twenty-sixth interface message includes fourth information. In some implementations, the twenty-sixth interface message may be a UE Context Setup Response or a UE Context Modification Response.

Step S1101-3: The central network node/central unit sends a twenty-seventh interface message to the first network node, where the twenty-seventh interface message includes the fourth information. In some implementations, the twenty-seventh interface message may be a UE Context Modification Request.

Step S1101-4: The first network node returns a twenty-eighth interface message to the central network node/central unit. In some implementations, the twenty-eighth interface message may be a UE Context Modification Response.

The PUCCH resource is shared by a plurality of terminals in one cell served by the first network node, or shared by a plurality of terminals in a plurality of cells served by the first network node.

In some implementations, a sequence between step S1100 and step S1101 may be interchanged.

Step S1102 is the same as step S502-2 in the foregoing embodiment, that is, the first network node sends a cell handover command to the target terminal, where the cell handover command is used to indicate the target terminal to perform handover to the target cell based on the uplink resource.

During some implementations, the first network node may obtain PUCCH resources of a plurality of candidate cells in advance, and share the PUCCH resources with a plurality of terminals. When the first network node needs to indicate a terminal in the plurality of terminals to perform cell handover, the terminal is set as the target terminal, the target cell is determined from the plurality of candidate cells, a PUCCH resource is selected from a PUCCH resource pool of the target cell and allocated for the target terminal, and a cell handover command is sent to the target terminal, to indicate the target terminal to perform handover to the target cell/a target cell group based on the selected PUCCH resource. In this case, the first network node suspends allocation of the selected PUCCH resource for another terminal.

In some implementations, in a case that the uplink resource is the PUCCH resource, the cell handover command includes at least one of the following:
an index associated with a configuration of the target cell;
a TCI state of the target cell;
the PUCCH resource of the target cell;
identification information associated with the PUCCH resource of the target cell;
a common RNTI associated with the PUCCH resource of the target cell; and
an indication of performing RACH-less handover in the target cell.

During some implementations, information that already exists in the RRC preconfiguration in step S1100 does not need to be repeatedly sent in the cell handover command in step S1102. For example, if the RRC preconfiguration in step S1100 includes an RNTI associated with an uplink resource configuration of the target cell, in step S1102, the RNTI associated with the uplink resource configuration of the target cell does not need to be sent in the cell handover command.

Correspondingly, step S1102 further includes:

Step S1102-2: The target terminal receives a first command.

Step S1102-3: The target terminal sends first uplink information to the second network node based on the uplink resource, where the first uplink information is used to perform cell handover.

In Implementation 6, the first uplink information is uplink control information transmitted based on the PUCCH resource. In some implementations, after receiving the cell handover command (first command) sent by the first network node, the target terminal determines, by using the RRC preconfiguration received in step S1100, a specific location of the PUCCH resource indicated in the cell handover command, and further sends the uplink control information to the second network node based on the PUCCH resource indicated in the cell handover command. In some implementations, the uplink control information may be SchedulingRequest (SR) information or Channel State Information (CSI). After receiving the uplink control information, the second network node performs step S1103.

Step S1103: The second network node sends, to the target terminal, second PDCCH information scrambled by a second common RNTI, where the second PDCCH information is used to schedule the target terminal to transmit PUSCH information on the PUSCH resource, and the second common RNTI is a common RNTI associated with the PUCCH resource.

Step S1104: The target terminal transmits the PUSCH information on the PUSCH resource based on the second PDCCH information, where the PUSCH information includes information used to carry an identifier of the target terminal.

In some implementations, the target terminal monitors the second PDCCH information sent by the second network node, obtains scheduling information of an uplink PUSCH resource through descrambling by using the common RNTI associated with the PUCCH resource, and then sends the PUSCH information to the second network node by using the PUSCH resource.

Step S1105: The second network node receives the PUSCH information, and parses the PUSCH information to obtain information used to carry an identifier of a terminal that performs cell handover.

In some implementations, the second network node detects the PUSCH information on the PUSCH resource to obtain the PUSCH information. After the PUSCH information is parsed, the information about the identifier of the terminal that performs cell handover is obtained. In some implementations, the information about the identifier is a C-RNTI MAC CE, and the terminal that performs cell handover is further determined by using the C-RNTI MAC CE.

After the target terminal completes the cell handover operation, the following steps are further included.

Step S1106 is the same as step S1006 in Implementation 5.

Step S1107 is the same as step S1007 in Implementation 5.

Step S1108 is the same as step S1008 in Implementation 5.

Correspondingly, after receiving the first PDCCH information, the target terminal releases the PUCCH resource indicated in the cell handover command in step S1102. In some implementations, after completing cell handover, the target terminal may directly release the PUCCH resource indicated in the cell handover command in step S1102.

In this implementation, the plurality of terminals served by the first network node share a PUCCH resource pool allocated by a same candidate cell. When the first network node indicates, by using the cell handover command, the target terminal to perform handover to the target cell, when performing cell handover (RACH-less handover), the target terminal sends the uplink control information based on the PUCCH resource indicated in the handover command, so that the second network node sends the scrambled second PDCCH information, and the target terminal transmits the PUSCH information on the corresponding PUSCH resource based on the second PDCCH information, so that the second network node identifies the terminal that performs cell handover. Therefore, Implementation 6 resolves how to determine the terminal that performs cell handover and how to release the shared PUCCH resource after cell handover is completed in a scenario in which the PUCCH resource is shared with the plurality of terminals served by the first network node.

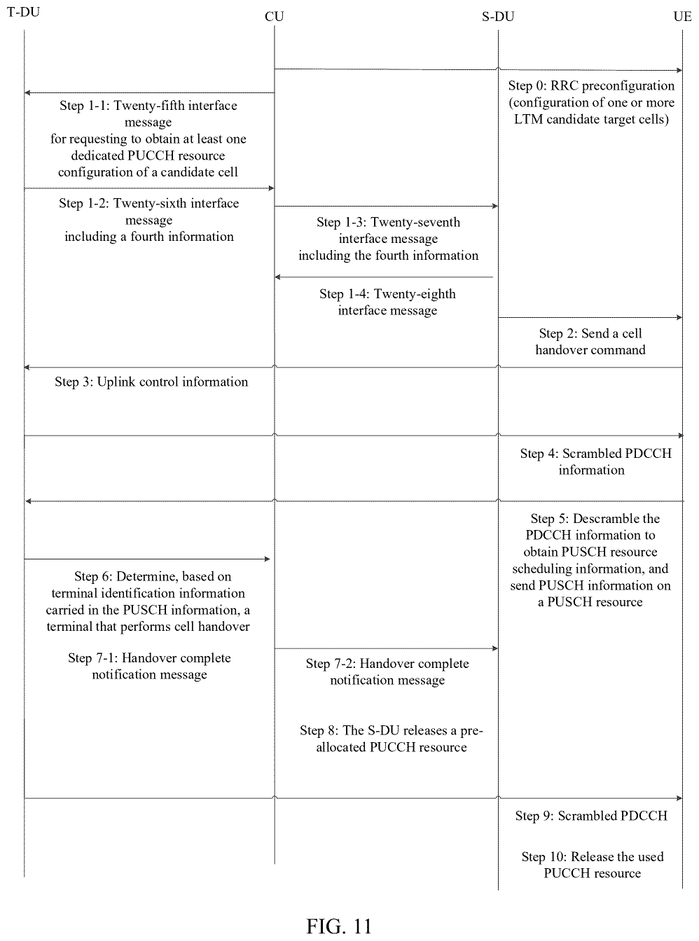

For example, FIG. 11 shows a process of performing cell handover based on the PUCCH resource in Implementation 6 in a case that the first network node and the second network node are two different network nodes that belong to a same central network node/central unit. As shown in FIG. 11, a plurality of interaction objects in Implementation 6 are a first network node S-DU, a second network node T-DU, a terminal UE, and a central network node/central unit CU. The following describes step 0 to step 10 in FIG. 11.
Step 0: The central network node/central unit provides an RRC preconfiguration for the terminal. In some implementations, the RRC preconfiguration includes a configuration of one or more LTM candidate cells. A configuration of each candidate cell includes fourth information, and the fourth information includes one of at least one PUCCH resource configuration allocated by the candidate cell for a terminal, identification information associated with each PUCCH resource configuration, and a common RNTI associated with each PUCCH resource configuration.
Step 1-1: The central network node/central unit sends a twenty-fifth interface message to the second network node, to request to obtain at least one PUSCH resource configuration of a candidate cell.
Step 1-2: The second network node returns a twenty-sixth interface message to the terminal, where the message includes the fourth information, so that the central unit obtains the at least one PUCCH resource configuration of the candidate cell from the second network node.
Step 1-3: The central network node/central unit sends a twenty-seventh interface message to the first network node.
Step 1-4: The first network node returns a twenty-eighth interface message to the central network node/central unit, to send the at least one PUCCH resource configuration of the candidate cell obtained from the second network node to the first network node.
Step 2: The first network node sends a cell handover command to the target terminal, to indicate the target terminal to perform handover to the target cell based on a PUCCH resource in the handover command.
Step 3: The target terminal sends uplink control information to the second network node by using the PUCCH resource in the handover command.
Step 4: After receiving the uplink control information, the second network node scrambles PDCCH information by using a common RNTI associated with the PDCCH resource, and sends the scrambled PDCCH information to the terminal.
Step 5: The terminal monitors the PDCCH information sent by the second network node, obtains scheduling information of an uplink PUSCH resource through descrambling by using the common RNTI associated with the PUCCH resource, and then sends the PUSCH information to the second network node based on the PUSCH resource, where the PUSCH information carries identification information of the terminal.
Step 6: The second network node determines, based on the terminal identification information carried in the PUSCH information, a terminal that performs cell handover.
Step 7-1: After determining that the terminal completes handover, the second network node sends a handover complete notification message to the central network node/central unit.
Step 7-2: The central network node/central unit sends the handover complete notification message to the first network node.
Step 8: After receiving the handover complete notification message, the first network node releases the pre-allocated PUCCH resource, that is, the first network node may continue to allocate the PUCCH resource for another terminal, so that the another terminal performs cell handover by using the PUCCH resource.
Step 9: The second network node sends scrambled PDCCH information to the terminal, to notify the terminal to release the PUCCH resource indicated by the handover command.
Step 10: After receiving the PDCCH information, the terminal releases the PUSCH resource indicated by the handover command.

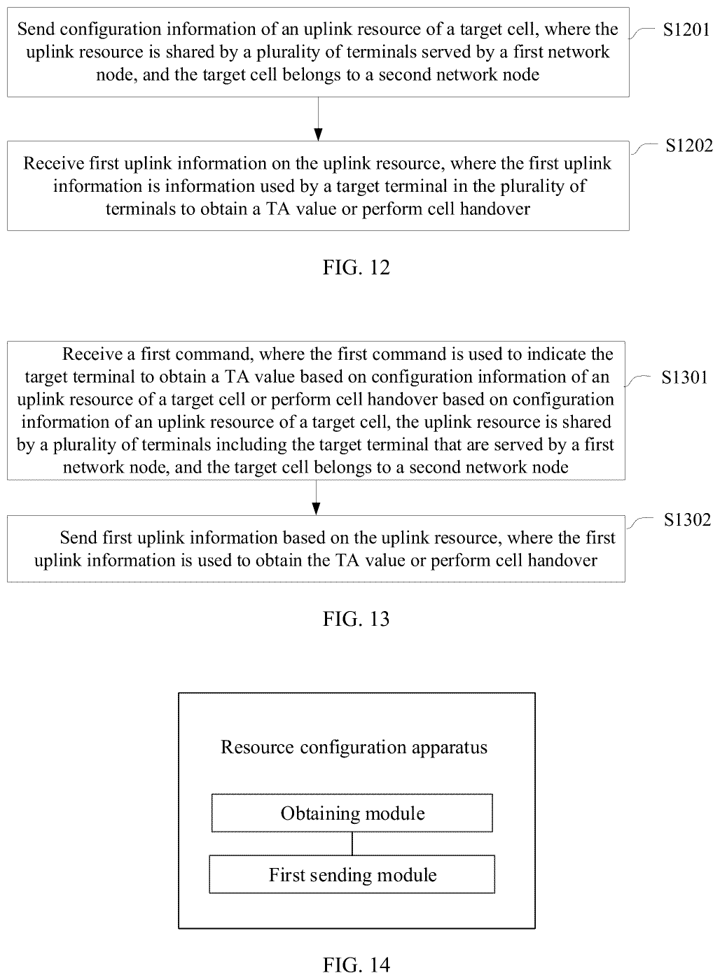

A second aspect of the embodiments of this application provides a resource configuration method. The method is applied to a second network node. Referring to FIG. 12, FIG. 12 is a flowchart of steps of a resource configuration method based on a second network node. As shown in FIG. 12, the resource configuration method may include the following steps.

Step S1201: Send configuration information of an uplink resource of a target cell, where the uplink resource is shared by a plurality of terminals served by a first network node, and the target cell belongs to the second network node.

Step S1202: Receive first uplink information on the uplink resource, where the first uplink information is information used by a target terminal in the plurality of terminals to obtain a TA value or perform cell handover.

In some implementations, the uplink resource includes at least one of the following:
a CFRA resource;
a PUSCH resource;
a PUCCH resource;
an SRS resource; and
another uplink signal/channel resource.

In some implementations, the configuration information of the uplink resource includes at least one of the following:
a configuration of the uplink resource;
identification information associated with the uplink resource; and
an RNTI associated with the uplink resource.

In some implementations, in a case that the uplink resource is the CFRA resource, configuration information of the CFRA resource includes at least one of the following:
an SS/PBCH index;
a PRACH mask index; and
a random access preamble index.

In some implementations, the first uplink information is a RACH Msg1; and the method further includes:
obtaining the TA value based on the RACH Msg1.

In some implementations, the method further includes at least one of the following: sending first information to the first network node, where the first information is information related to an uplink resource based on which the TA value is obtained; and sending a RACH Msg2 to the target terminal, where the RACH Msg2 includes at least the TA value of the target cell.

In some implementations, the first information includes at least one of the following: the TA value of the target cell;
the configuration information of the uplink resource and/or identification information associated with the uplink resource;
identification information of the uplink resource; and
power control information for sending a PUSCH.

In some implementations, before the obtaining the TA value based on the RACH Msg1, the method further includes:
receiving first notification information, where the first notification information includes identification information of the target terminal and the configuration information of the uplink resource.

The method further includes:
determining, based on the first notification information, identification information of a terminal to which the TA value corresponds; and
sending second information, where the second information is information related to an identifier of the terminal to which the TA value corresponds.

In some implementations, the second information includes at least one of the following: the TA value of the target cell;
the identification information of the target terminal; and
power control information for sending a PUSCH.

In some implementations, the method further includes:
receiving first notification information, where the first notification information includes identification information of the target terminal and the configuration information of the uplink resource;
determining, based on the first notification information, identification information of a terminal that performs cell handover based on the uplink resource; and
in a case that the second network node and the first network node are a same network node, determining that the terminal that performs cell handover is the target terminal.

In some implementations, the method further includes:
sending a RACH Msg2, where the RACH Msg2 includes the TA value of the target cell;
in a case that the second network node and the first network node are different network nodes, receiving a RACH Msg3, where the RACH Msg3 includes information used to carry an identifier of a terminal that performs cell handover;
determining, based on the RACH Msg3, the terminal that performs cell handover; and
sending a RACH Msg4, where the RACH Msg4 is scrambled by a target RNTI, the RACH Msg4 includes an uplink grant for scheduling new transmission, and the target RNTI is a C-RNTI allocated by the target cell for the terminal that performs cell handover.

In some implementations, in a case that the uplink resource is the PUSCH resource, the first uplink information is PUSCH information transmitted based on the PUSCH resource and scrambled by a first common RNTI, and the method further includes:
descrambling the PUSCH information on the PUSCH resource based on the first common RNTI to obtain information used to carry an identifier of a terminal that performs cell handover, where the first common RNTI is a common RNTI associated with the PUSCH resource;
determining, based on the information used to carry the identifier of the terminal that performs cell handover, the terminal that performs cell handover; and/or sending first PDCCH information, where the first PDCCH information is scrambled by an RNTI associated with information used to carry an identifier of the target terminal, and the first PDCCH information represents that the target terminal completes cell handover.

In some implementations, in a case that the uplink resource is the PUCCH resource, the first uplink information is uplink control information transmitted based on the PUCCH resource, and the method further includes:
sending second PDCCH information scrambled by a second common RNTI, where the second PDCCH information is used to schedule the target terminal to transmit PUSCH information on the PUSCH resource, and the second common RNTI is a common RNTI associated with the PUCCH resource;
receiving the PUSCH information; and
parsing the PUSCH information to obtain information used to carry an identifier of a terminal that performs cell handover.

A third aspect of the embodiments of this application provides a resource configuration method. The method is applied to a target terminal. Referring to FIG. 13, FIG. 13 is a flowchart of steps of a resource configuration method based on a target terminal. As shown in FIG. 13, the resource configuration method may include the following steps.

Step S1301: Receive a first command, where the first command is used to indicate the target terminal to obtain a TA value based on configuration information of an uplink resource of a target cell or perform cell handover based on configuration information of an uplink resource of a target cell, the uplink resource is shared by a plurality of terminals including the target terminal that are served by a first network node, and the target cell belongs to a second network node.

Step S1302: Send first uplink information based on the uplink resource, where the first uplink information is used to obtain the TA value or perform cell handover.

In some implementations, the uplink resource includes at least one of the following:
a CFRA resource;
a PUSCH resource;
a PUCCH resource;
an SRS resource; and
another uplink signal/channel resource.

In some implementations, the configuration information of the uplink resource includes at least one of the following:
a configuration of the uplink resource;
identification information associated with the uplink resource; and
an RNTI associated with the uplink resource.

In some implementations, in a case that the uplink resource is the CFRA resource, configuration information of the CFRA resource includes at least one of the following: an SS/PBCH index;
a PRACH mask index; and
a random access preamble index.

In some implementations, the method further includes:
releasing the uplink resource when the TA value is obtained or cell handover is completed.

In some implementations, the receiving a first command includes at least one of the following:
receiving a sent PDCCH order, where the PDCCH order is used to indicate the target terminal to initiate contention-free random access based on the uplink resource; and
receiving a cell handover command, where the cell handover command is used to indicate the target terminal to perform handover to the target cell based on the uplink resource.

In some implementations, the first uplink information is a RACH Msg1, and in a case that the first command is the cell handover command, the method further includes:
receiving a RACH Msg2, where the RACH Msg2 includes the TA value of the target cell;
in a case that the second network node and the first network node are different network nodes, sending a RACH Msg3, where the RACH Msg3 includes information used to carry an identifier of the target terminal; and
receiving a RACH Msg4, where the RACH Msg4 is scrambled by a target RNTI, the RACH Msg4 includes an uplink grant for scheduling new transmission, and the target RNTI is a C-RNTI allocated by the target cell for a terminal that performs cell handover.

In some implementations, in a case that the uplink resource is the PUSCH resource, the cell handover command includes at least one of the following:
an index associated with a configuration of the target cell;
a TCI state of the target cell;
the PUSCH resource of the target cell;
identification information associated with the PUSCH resource of the target cell;
a common RNTI associated with the PUSCH resource of the target cell; and
an indication of performing RACH-less handover in the target cell.

In some implementations, in a case that the uplink resource is the PUCCH resource, the cell handover command includes at least one of the following:
an index associated with a configuration of the target cell;
a TCI state of the target cell;
the PUCCH resource of the target cell;
identification information associated with the PUCCH resource of the target cell;
a common RNTI associated with the PUCCH resource of the target cell; and
an indication of performing RACH-less handover in the target cell.

In some implementations, the method further includes:
receiving an RRC preconfiguration, where the RRC preconfiguration includes at least one of the following:
an uplink resource configuration of the target cell;
identification information associated with the uplink resource configuration of the target cell; and
a common RNTI associated with the uplink resource of the target cell.

In some implementations, the target RNTI is determined based on the received cell handover command or RRC preconfiguration.

In some implementations, the method further includes:
determining, based on the RRC preconfiguration and the first command, whether the second network node and the first network node are a same network node, where the RRC preconfiguration includes a list of source cells that belong to a same network node as each target cell; and
if a source cell in which the target terminal is located is in a source cell list associated with the target cell indicated by the first command, determining that the second network node and the first network node are the same network node; or if a source cell in which the target terminal is located is not in a source cell list associated with the target cell indicated by the first command, determining that the second network node and the first network node are different network nodes.

In some implementations, in a case that the uplink resource is the PUSCH resource, the first uplink information is PUSCH information transmitted based on the PUSCH resource and scrambled by a first common RNTI, the PUSCH information includes information used to carry an identifier of the target terminal, and the first common RNTI is a common RNTI associated with the PUSCH resource; and the method further includes:
receiving first PDCCH information, where the first PDCCH information is scrambled by an RNTI associated with the information used to carry the identifier of the target terminal, and the first PDCCH information represents that the target terminal completes cell handover.

In some implementations, in a case that the uplink resource is the PUCCH resource, the first uplink information is uplink control information transmitted based on the PUCCH resource, and the method further includes:
receiving second PDCCH information scrambled by a second common RNTI, where the second common RNTI is a common RNTI associated with the PUCCH resource, and the second PDCCH information is used to schedule the target terminal to transmit PUSCH information on the PUSCH resource;
transmitting the PUSCH information on the PUSCH resource based on the second PDCCH information, where the PUSCH information includes information used to carry an identifier of the target terminal; and/or
receiving first PDCCH information, where the first PDCCH information is scrambled by an RNTI associated with the information used to carry the identifier of the target terminal, and the first PDCCH information represents that the target terminal completes cell handover.

The resource configuration method provided in the embodiments of this application may be performed by a resource configuration apparatus. In the embodiments of this application, an example in which the resource configuration apparatus performs the resource configuration method described in the foregoing embodiments is used to describe the resource configuration apparatus provided in the embodiments of this application.

A fourth aspect of the embodiments of this application provides a resource configuration apparatus. Referring to FIG. 14, FIG. 14 is a schematic diagram of a structure of a resource configuration apparatus. As shown in FIG. 14, the apparatus includes:
an obtaining module, configured to obtain configuration information of an uplink resource of a target cell, where the uplink resource is shared by a plurality of terminals served by a first network node; and
a first sending module, configured to send a first command, where the first command is used to allocate at least a part of the obtained uplink resource of the target cell for a target terminal in the plurality of terminals, and indicate the target terminal to obtain a timing advance TA value of the target cell based on the uplink resource or perform handover to the target cell based on the uplink resource, and the target cell belongs to a second network node.

In some implementations, the apparatus further includes at least one of the following:
a suspension module, configured to suspend allocation of the uplink resource for a terminal other than the target terminal in the plurality of terminals; and
an allocation module, configured to: in a case that information related to an uplink resource based on which the TA value is obtained is received or in a case that a notification message representing that cell handover is completed is received, continue to allocate the uplink resource for a terminal that needs to obtain the TA value or perform cell handover in the plurality of terminals.

In some implementations, the uplink resource includes at least one of the following:
a contention-free random access CFRA resource;
a physical uplink shared channel PUSCH resource;
a physical uplink control channel PUCCH resource;
a sounding reference signal SRS resource; and
another uplink signal/channel resource.

In some implementations, the configuration information of the uplink resource includes at least one of the following:
a configuration of the uplink resource;
identification information associated with the uplink resource; and
a radio network temporary identifier RNTI associated with the uplink resource.

In some implementations, in a case that the uplink resource is the CFRA resource, configuration information of the CFRA resource includes at least one of the following:
an SS/PBCH index;
a PRACH mask index; and
a random access preamble index.

In some implementations, the first sending module includes at least one of the following: a first sending submodule, configured to send a physical downlink control channel order (PDCCH order), where the PDCCH order is used to indicate the target terminal to initiate contention-free random access to the target cell based on the uplink resource; and a second sending submodule, configured to send a cell handover command, where the cell handover command is used to indicate the target terminal to perform handover to the target cell based on the uplink resource.

In some implementations, the cell handover command includes at least one of the following:
an index associated with a configuration of the target cell;
a TCI state of the target cell;
the PUSCH resource of the target cell;
identification information associated with the PUSCH resource of the target cell;
a common RNTI associated with the PUSCH resource of the target cell;
the PUCCH resource of the target cell;
identification information associated with the PUCCH resource of the target cell;
a common RNTI associated with the PUCCH resource of the target cell;
the TA value of the target cell; and
an indication of performing RACH-less handover in the target cell.

In some implementations, in a case that the uplink resource is the PUSCH resource, the cell handover command includes at least one of the following:
an index associated with a configuration of the target cell;
a TCI state of the target cell;
the PUSCH resource of the target cell;
identification information associated with the PUSCH resource of the target cell;
a common RNTI associated with the PUSCH resource of the target cell; and
an indication of performing RACH-less handover in the target cell.

In some implementations, in a case that the uplink resource is the PUCCH resource, the cell handover command includes at least one of the following:
an index associated with a configuration of the target cell;
a TCI state of the target cell;
the PUCCH resource of the target cell;
identification information associated with the PUCCH resource of the target cell;
a common RNTI associated with the PUCCH resource of the target cell; and
an indication of performing RACH-less handover in the target cell.

In some implementations, the apparatus further includes:
a first receiving module, configured to receive first information, where the first information is information related to an uplink resource based on which the TA value is obtained; and
a first determining module, configured to determine, based on the first information, that the TA value corresponds to the target terminal.

In some implementations, the first information includes at least one of the following: the TA value of the target cell;
the configuration information of the uplink resource and/or identification information associated with the uplink resource;
identification information of the uplink resource; and
power control information for sending a PUSCH.

In some implementations, the apparatus further includes:
a first notification information sending module, configured to send first notification information, where the first notification information includes identification information of the target terminal and the configuration information of the uplink resource and/or identification information of the configuration information of the uplink resource;
a second information receiving module, configured to receive second information, where the second information is information related to an identifier of a terminal to which the TA value corresponds; and
a second information determining module, configured to determine, based on the second information, that the TA value corresponds to the target terminal.

In some implementations, the second information includes at least one of the following: the TA value of the target cell;
the identification information of the target terminal; and
power control information for sending a PUSCH.

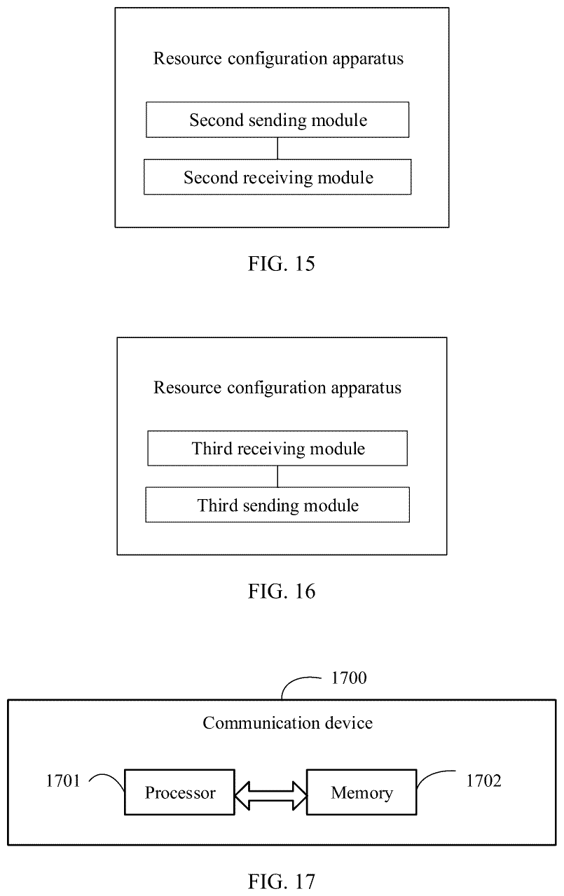

A fifth aspect of the embodiments of this application provides a resource configuration apparatus. Referring to FIG. 15, FIG. 15 is a schematic diagram of a structure of a resource configuration apparatus. As shown in FIG. 15, the apparatus includes:

a second sending module, configured to send configuration information of an uplink resource of a target cell, where the uplink resource is shared by a plurality of terminals served by a first network node, and the target cell belongs to a second network node; and a second receiving module, configured to receive first uplink information on the uplink resource, where the first uplink information is information used by a target terminal in the plurality of terminals to obtain a TA value or perform cell handover.

In some implementations, the uplink resource includes at least one of the following:
a CFRA resource;
a PUSCH resource;
a PUCCH resource;
an SRS resource; and
another uplink signal/channel resource.

In some implementations, the configuration information of the uplink resource includes at least one of the following:
a configuration of the uplink resource;
identification information associated with the uplink resource; and
an RNTI associated with the uplink resource.

In some implementations, in a case that the uplink resource is the CFRA resource, configuration information of the CFRA resource includes at least one of the following:
an SS/PBCH index;
a PRACH mask index; and
a random access preamble index.

In some implementations, the first uplink information is a RACH Msg1; and the apparatus further includes:
a second obtaining module, configured to obtain the TA value based on the RACH Msg1.

In some implementations, the apparatus further includes at least one of the following:
a first information sending module, configured to send first information to the first network node, where the first information is information related to an uplink resource based on which the TA value is obtained; and
a RACH Msg2 sending module, configured to send a RACH Msg2 to the target terminal, where the RACH Msg2 includes at least the TA value of the target cell.

In some implementations, the first information includes at least one of the following: the TA value of the target cell;
the configuration information of the uplink resource and/or identification information associated with the uplink resource;
identification information of the uplink resource; and
power control information for sending a PUSCH.

In some implementations, the apparatus further includes:
a first notification information receiving module, configured to receive first notification information, where the first notification information includes identification information of the target terminal and the configuration information of the uplink resource.

The apparatus further includes:
a second determining module, configured to determine, based on the first notification information, identification information of a terminal to which the TA value corresponds; and
a second information sending module, configured to send second information, where the second information is information related to an identifier of the terminal to which the TA value corresponds.

In some implementations, the second information includes at least one of the following: the TA value of the target cell;
the identification information of the target terminal; and
power control information for sending a PUSCH.

In some implementations, the apparatus further includes:
a receiving module, configured to receive first notification information, where the first notification information includes identification information of the target terminal and the configuration information of the uplink resource;
a first notification information determining module, configured to determine, based on the first notification information, identification information of a terminal that performs cell handover based on the uplink resource; and
a first terminal determining module, configured to: in a case that the second network node and the first network node are a same network node, determine that the terminal that performs cell handover is the target terminal.

In some implementations, the apparatus further includes:
a RACH Msg2 sending module, configured to send a RACH Msg2, where the RACH Msg2 includes the TA value of the target cell;
a RACH Msg3 receiving module, configured to: in a case that the second network node and the first network node are different network nodes, receive a RACH Msg3, where the RACH Msg3 includes information used to carry an identifier of a terminal that performs cell handover;
a RACH Msg3 determining module, configured to determine, based on the RACH Msg3, the terminal that performs cell handover; and
a RACH Msg4 sending module, configured to send a RACH Msg4, where the RACH Msg4 is scrambled by a target RNTI, the RACH Msg4 includes an uplink grant for scheduling new transmission, and the target RNTI is a C-RNTI allocated by the target cell for the terminal that performs cell handover.

In some implementations, in a case that the uplink resource is the PUSCH resource, the first uplink information is PUSCH information transmitted based on the PUSCH resource and scrambled by a first common RNTI, and the apparatus further includes:
a PUSCH resource descrambling module, configured to descramble the PUSCH information on the PUSCH resource based on the first common RNTI to obtain information used to carry an identifier of a terminal that performs cell handover, where the first common RNTI is a common RNTI associated with the PUSCH resource;
a second terminal determining module, configured to determine, based on the information used to carry the identifier of the terminal that performs cell handover, the terminal that performs cell handover; and/or
a first PDCCH information sending module, configured to send first PDCCH information, where the first PDCCH information is scrambled by an RNTI associated with information used to carry an identifier of the target terminal, and the first PDCCH information represents that the target terminal completes cell handover.

In some implementations, in a case that the uplink resource is the PUCCH resource, the first uplink information is uplink control information transmitted based on the PUCCH resource, and the apparatus further includes:
a second PDCCH information sending module, configured to send second PDCCH information scrambled by a second common RNTI, where the second PDCCH information is used to schedule the target terminal to transmit PUSCH information on the PUSCH resource, and the second common RNTI is a common RNTI associated with the PUCCH resource;
a PUSCH information receiving module, configured to receive the PUSCH information; and
a PUSCH information parsing module, configured to parse the PUSCH information to obtain information used to carry an identifier of a terminal that performs cell handover.

A sixth aspect of the embodiments of this application provides a resource configuration apparatus. Referring to FIG. 16, FIG. 16 is a schematic diagram of a structure of a resource configuration apparatus. As shown in FIG. 16, the apparatus includes:
a third receiving module, configured to receive a first command, where the first command is used to indicate the target terminal to obtain a TA value based on configuration information of an uplink resource of a target cell or perform cell handover based on configuration information of an uplink resource of a target cell, the uplink resource is shared by a plurality of terminals including the target terminal that are served by a first network node, and the target cell belongs to a second network node; and a third sending module, configured to send first uplink information based on the uplink resource, where the first uplink information is used to obtain the TA value or perform cell handover.

In some implementations, the uplink resource includes at least one of the following:
a CFRA resource;
a PUSCH resource;
a PUCCH resource;
an SRS resource; and
another uplink signal/channel resource.

In some implementations, the configuration information of the uplink resource includes at least one of the following:
a configuration of the uplink resource;
identification information associated with the uplink resource; and
an RNTI associated with the uplink resource.

In some implementations, in a case that the uplink resource is the CFRA resource, configuration information of the CFRA resource includes at least one of the following:
an SS/PBCH index;
a PRACH mask index; and
a random access preamble index.

In some implementations, the apparatus further includes:
a processing module, configured to release the uplink resource when the TA value is obtained or cell handover is completed.

In some implementations, the third receiving module includes at least one of the following: a PDCCH order receiving submodule, configured to receive a sent PDCCH order, where the PDCCH order is used to indicate the target terminal to initiate contention-free random access based on the uplink resource; and
a cell handover command receiving submodule, configured to receive a cell handover command, where the cell handover command is used to indicate the target terminal to perform handover to the target cell based on the uplink resource.

In some implementations, the first uplink information is a RACH Msg1, and in a case that the first command is the cell handover command, the apparatus further includes:
a RACH Msg2 receiving module, configured to receive a RACH Msg2, where the RACH Msg2 includes the TA value of the target cell;
a RACH Msg3 sending module, configured to: in a case that the second network node and the first network node are different network nodes, send a RACH Msg3, where the RACH Msg3 includes information used to carry an identifier of the target terminal; and a RACH Msg4 receiving module, configured to receive a RACH Msg4, where the RACH Msg4 is scrambled by a target RNTI, the RACH Msg4 includes an uplink grant for scheduling new transmission, and the target RNTI is a C-RNTI allocated by the target cell for a terminal that performs cell handover.

In some implementations, in a case that the uplink resource is the PUSCH resource, the cell handover command includes at least one of the following:
an index associated with a configuration of the target cell;
a TCI state of the target cell;
the PUSCH resource of the target cell;
identification information associated with the PUSCH resource of the target cell;
a common RNTI associated with the PUSCH resource of the target cell; and
an indication of performing RACH-less handover in the target cell.

In some implementations, in a case that the uplink resource is the PUCCH resource, the cell handover command includes at least one of the following:
an index associated with a configuration of the target cell;
a TCI state of the target cell;
the PUCCH resource of the target cell;
identification information associated with the PUCCH resource of the target cell;
a common RNTI associated with the PUCCH resource of the target cell; and
an indication of performing RACH-less handover in the target cell.

In some implementations, the apparatus further includes:
a third receiving module, configured to receive an RRC preconfiguration, where the RRC preconfiguration includes at least one of the following:
an uplink resource configuration of the target cell;
identification information associated with the uplink resource configuration of the target cell; and
a common RNTI associated with the uplink resource of the target cell.

In some implementations, the target RNTI is determined based on the received cell handover command or RRC preconfiguration.

In some implementations, the apparatus further includes:
a first determining module, configured to determine, based on the RRC preconfiguration and the first command, whether the second network node and the first network node are a same network node, where the RRC preconfiguration includes a list of source cells that belong to a same network node as each target cell; and
a second determining module, configured to: if a source cell in which the target terminal is located is in a source cell list associated with the target cell indicated by the first command, determine that the second network node and the first network node are the same network node; or a third determining module, configured to: if a source cell in which the target terminal is located is not in a source cell list associated with the target cell indicated by the first command, determine that the second network node and the first network node are different network nodes.

In some implementations, in a case that the uplink resource is the PUSCH resource, the first uplink information is PUSCH information transmitted based on the PUSCH resource and scrambled by a first common RNTI, the PUSCH information includes information used to carry an identifier of the target terminal, and the first common RNTI is a common RNTI associated with the PUSCH resource; and the apparatus further includes:
a first PDCCH information receiving module, configured to receive first PDCCH information, where the first PDCCH information is scrambled by an RNTI associated with the information used to carry the identifier of the target terminal, and the first PDCCH information represents that the target terminal completes cell handover.

In some implementations, in a case that the uplink resource is the PUCCH resource, the first uplink information is uplink control information transmitted based on the PUCCH resource, and the apparatus further includes:
a second PDCCH information receiving module, configured to receive second PDCCH information scrambled by a second common RNTI, where the second common RNTI is a common RNTI associated with the PUCCH resource, and the second PDCCH information is used to schedule the target terminal to transmit PUSCH information on the PUSCH resource;
a PUSCH information transmission module, configured to transmit the PUSCH information on the PUSCH resource based on the second PDCCH information, where the PUSCH information includes information used to carry an identifier of the target terminal; and/or
a first PDCCH information receiving module, configured to receive first PDCCH information, where the first PDCCH information is scrambled by an RNTI associated with the information used to carry the identifier of the target terminal, and the first PDCCH information represents that the target terminal completes cell handover.

The resource configuration apparatus in the foregoing embodiments of this application may be an electronic device, for example, an electronic device with an operating system, or may be a component such as an integrated circuit or a chip in an electronic device. The electronic device may be a terminal, or may be another device different from a terminal. For example, the terminal may include but is not limited to the foregoing listed types of the terminal 11. The another device may be a server, a network attached storage (Network Attached Storage, NAS), or the like. This is not specifically limited in the embodiments of this application.

The resource configuration apparatus provided in the embodiments of this application can implement various processes implemented in the method embodiments of FIG. 5 to FIG. 13, and achieve the same technical effects. To avoid repetition, details are not described herein again.

As shown in FIG. 17, an embodiment of this application further provides a communication device 1700, including a processor 1701 and a memory 1702. The memory 1702 stores a program or instructions capable of running on the processor 1701. For example, when the communication device 1700 is a terminal, the program or the instructions are executed by the processor 1701 to implement the steps in the foregoing embodiments of the resource configuration method, and the same technical effects can be achieved. When the communication device 1700 is a network side device, the program or the instructions are executed by the processor 1701 to implement the steps in the foregoing embodiments of the resource configuration method, and the same technical effects can be achieved. To avoid repetition, details are not described herein again.

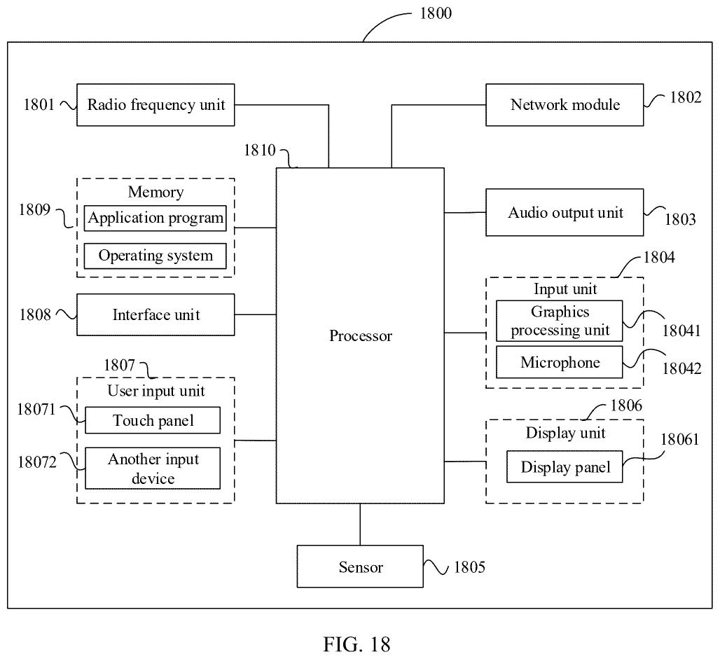

An embodiment of this application further provides a terminal, including a processor and a communication interface. The communication interface is coupled to the processor. The processor is configured to run a program or instructions to implement the steps in the method embodiments shown in FIG. 5 to FIG. 13. This terminal embodiment is corresponding to the foregoing terminal side method embodiment. Each implementation process and implementation of the foregoing method embodiment may be applied to this terminal embodiment, and the same technical effects can be achieved. In some implementations, FIG. 18 is a schematic diagram of a hardware structure of a terminal for implementing an embodiment of this application.

The terminal 1800 includes but is not limited to at least some of the following components: a radio frequency unit 1801, a network module 1802, an audio output unit 1803, an input unit 1804, a sensor 1805, a display unit 1806, a user input unit 1807, an interface unit 1808, a memory 1809, a processor 1810, and the like.

A person skilled in the art may understand that the terminal 1800 may further include a power supply (for example, a battery) that supplies power to each component. The power supply may be logically connected to the processor 1810 by using a power management system, so as to implement functions such as charging management, discharging management, and power consumption management by using the power management system. The structure of the terminal shown in FIG. 18 does not constitute a limitation on the terminal. The terminal may include more or fewer components than those shown in the figure, or combine some components, or have different component arrangements. Details are not described herein again.

It should be understood that in this embodiment of this application, the input unit 1804 may include a Graphics Processing Unit (GPU) 18041 and a microphone 18042. The graphics processing unit 18041 processes image data of a still picture or a video obtained by an image capture apparatus (for example, a camera) in a video capture mode or an image capture mode. The display unit 1806 may include a display panel 18061, and the display panel 18061 may be configured in a form of a liquid crystal display, an organic light-emitting diode, or the like. The user input unit 1807 includes at least one of a touch panel 18071 and another input device 18072. The touch panel 18071 is also referred to as a touchscreen. The touch panel 18071 can include two parts: a touch detection apparatus and a touch controller. The another input device 18072 may include but is not limited to a physical keyboard, a function key (such as a volume control key or an on/off key), a trackball, a mouse, and a joystick. Details are not described herein again.

In this embodiment of this application, after receiving downlink data from a network side device, the radio frequency unit 1801 may transmit the downlink data to the processor 1810 for processing. In addition, the radio frequency unit 1801 may send uplink data to the network side device. Generally, the radio frequency unit 1801 includes but is not limited to an antenna, an amplifier, a transceiver, a coupler, a low-noise amplifier, a duplexer, and the like.

The memory 1809 may be configured to store a software program or instructions and various types of data. The memory 1809 may mainly include a first storage area for storing a program or instructions and a second storage area for storing data. The first storage area may store an operating system, an application program or instructions required by at least one function (for example, a sound play function or an image play function), and the like. In addition, the memory 1809 may include a volatile memory or a nonvolatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1809 in this embodiment of this application includes but is not limited to these memories and any other suitable type of memory.

The processor 1810 may include one or more processing units. In some implementations, the processor 1810 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1810.

It may be understood that for implementation processes of the implementations mentioned in this embodiment, reference may be made to related descriptions in the method embodiment, and same or corresponding technical effects are achieved. To avoid repetition, details are not described herein again.

An embodiment of this application further provides a network side device, including a processor and a communication interface. The communication interface is coupled to the processor. The processor is configured to run a program or instructions to implement the steps in the method embodiments shown in FIG. 5 to FIG. 13. This network side device embodiment is corresponding to the foregoing method embodiment for the network side device, and each implementation process and implementation of the foregoing method embodiment can be applied to this network side device embodiment, and the same technical effects can be achieved.

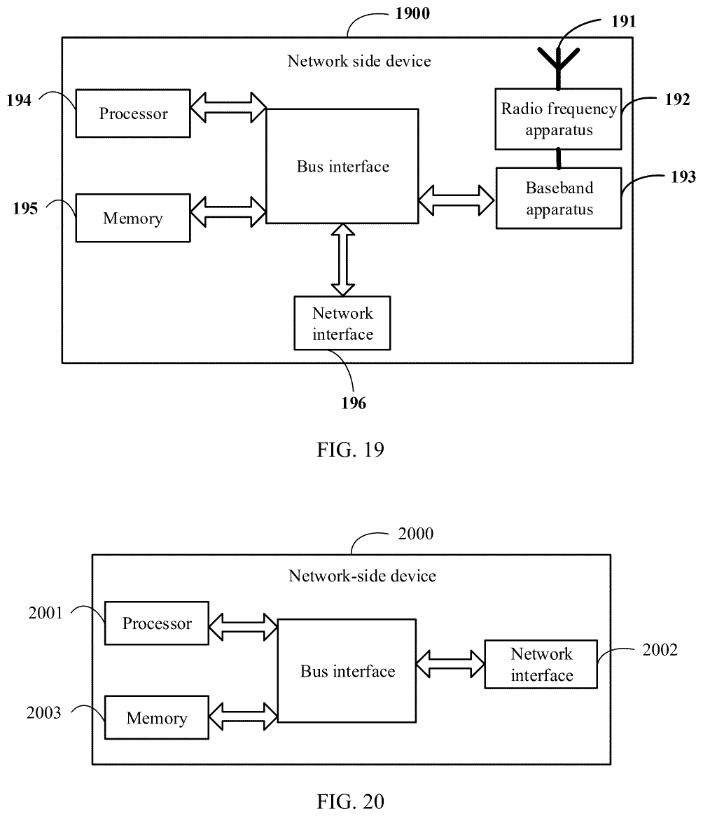

In some implementations, an embodiment of this application further provides a network side device. As shown in FIG. 19, the network side device 1900 includes an antenna 191, a radio frequency apparatus 192, a baseband apparatus 193, a processor 194, and a memory 195. The antenna 191 is connected to the radio frequency apparatus 192. In an uplink direction, the radio frequency apparatus 192 receives information through the antenna 191, and sends the received information to the baseband apparatus 193 for processing. In a downlink direction, the baseband apparatus 193 processes to-be-sent information, and sends processed information to the radio frequency apparatus 192. After processing the received information, the radio frequency apparatus 192 sends processed information through the antenna 191.

The method performed by the network side device in the foregoing embodiment may be implemented in the baseband apparatus 193. The baseband apparatus 193 includes a baseband processor.

For example, the baseband apparatus 193 may include at least one baseband board. A plurality of chips are disposed on the baseband board. As shown in FIG. 19, one of the chips is, for example, the baseband processor, and is connected to the memory 195 by using a bus interface, to invoke a program in the memory 195 to perform an operation of a network device shown in the foregoing method embodiment.

The network side device may further include a network interface 196, and the interface is, for example, a Common Public Radio Interface (CPRI).

In some implementations, the network side device 1900 in this embodiment of this application further includes instructions or a program stored in the memory 195 and capable of running on the processor 194. The processor 194 invokes the instructions or the program in the memory 195 to perform the method performed by the modules shown in FIG. 14 or FIG. 15, and the same technical effects are achieved. To avoid repetition, details are not described herein again.

In some implementations, an embodiment of this application further provides a network side device. As shown in FIG. 20, the network side device 2000 includes a processor 2001, a network interface 2002, and a memory 2003. The network interface 2002 is, for example, a CPRI.

In some implementations, the network side device 2000 in this embodiment of this application further includes instructions or a program stored in the memory 2003 and capable of running on the processor 2001. The processor 2001 invokes the instructions or the program in the memory 2003 to perform the method performed by the modules shown in FIG. 14 or FIG. 15, and the same technical effects are achieved. To avoid repetition, details are not described herein again.

An embodiment of this application further provides a readable storage medium. The readable storage medium stores a program or instructions. When the program or the instructions are executed by a processor, processes in the foregoing embodiments of the resource configuration method are implemented, and the same technical effects can be achieved. To avoid repetition, details are not described herein again.

The processor is a processor in the terminal described in the foregoing embodiments. The readable storage medium includes a computer-readable storage medium, for example, a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface. The communication interface is coupled to the processor. The processor is configured to run a program or instructions to implement processes in the foregoing embodiments of the resource configuration method, and the same technical effects can be achieved. To avoid repetition, details are not described herein again.

It should be understood that the chip mentioned in this embodiment of this application can also be referred to as a system-level chip, a system chip, a chip system, a system on chip, or the like.

An embodiment of this application further provides a computer program/program product. The computer program/program product is stored in a storage medium. The computer program/program product is executed by at least one processor to implement processes in the foregoing embodiments of the resource configuration method, and the same technical effects can be achieved. To avoid repetition, details are not described herein again.

An embodiment of this application further provides a resource configuration system, including a terminal and a network side device. The terminal may be configured to perform the steps of the resource configuration method described above, and the network side device may be configured to perform the steps of the resource configuration method described above.

It should be noted that, the terms “include,” “comprise,” or any other variation thereof in this specification are intended to cover a non-exclusive inclusion, so that a process, method, article, or apparatus that includes a list of elements includes the elements, and also includes other elements that are not expressly listed, or further includes elements inherent to such a process, method, article, or apparatus. Without more limitations, elements defined by the sentence “including one” does not exclude that there are still other same elements in the processes, methods, objects, or apparatuses that include the elements. In addition, it should be noted that the scope of the method and apparatus in the implementations of this application is not limited to performing functions in a sequence shown or discussed, and may further include performing functions in a basically simultaneous manner or in a reverse sequence based on related functions. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a storage medium (such as a ROM, a RAM, a magnetic disk, or an optical disc) and includes several instructions for instructing a terminal or a network side device to perform the methods described in the embodiments of this application.

The foregoing describes the embodiments of this application with reference to the accompanying drawings. However, this application is not limited to the foregoing specific implementations. The foregoing specific implementations are merely illustrative rather than restrictive. Inspired by this application, a person of ordinary skill in the art may develop many forms of implementations without departing from principles of this application and the protection scope of the claims, and all such implementations fall within the protection scope of this application.

1. A resource configuration method, performed by a first network node, and comprising:
obtaining configuration information of an uplink resource of a target cell, wherein the uplink resource is shared by a plurality of terminals served by the first network node; and
sending a first command,
wherein the first command is used to allocate at least a part of the obtained uplink resource of the target cell for a target terminal in the plurality of terminals, and indicate the target terminal to obtain a Timing Advance (TA) value of the target cell based on the uplink resource or perform handover to the target cell based on the uplink resource, and the target cell belongs to a second network node.

2. The resource configuration method according to claim 1, wherein after the sending a first command, the method further comprises at least one of the following:
suspending allocation of the uplink resource for a terminal other than the target terminal in the plurality of terminals; or
when information related to an uplink resource based on which the TA value is obtained is received or when a notification message representing that cell handover is completed is received, continuing to allocate the uplink resource for the terminal that needs to obtain the TA value or perform cell handover in the plurality of terminals.

3. The resource configuration method according to claim 1, wherein the sending a first command comprises at least one of the following:
sending a Physical Downlink Control CHannel (PDCCH) order, wherein the PDCCH order is used to indicate the target terminal to initiate contention-free random access to the target cell based on the uplink resource; or
sending a cell handover command, wherein the cell handover command is used to indicate the target terminal to perform handover to the target cell based on the uplink resource.

4. The resource configuration method according to claim 1, wherein after the sending a first command, the method further comprises:
receiving first information, wherein the first information is information related to an uplink resource based on which the TA value is obtained; and
determining, based on the first information, that the TA value corresponds to the target terminal.

5. The resource configuration method according to claim 1, wherein after the sending a first command, the method further comprises:
sending first notification information, wherein the first notification information comprises identification information of the target terminal and the configuration information of the uplink resource or identification information of the configuration information of the uplink resource;
receiving second information, wherein the second information is information related to an identifier of a terminal to which the TA value corresponds; and
determining, based on the second information, that the TA value corresponds to the target terminal.

6. A resource configuration method, performed by a second network node, wherein the method comprises:
sending configuration information of an uplink resource of a target cell, wherein the uplink resource is shared by a plurality of terminals served by a first network node, and the target cell belongs to the second network node; and
receiving first uplink information on the uplink resource, wherein the first uplink information is information used by a target terminal in the plurality of terminals to obtain a Timing Advance (TA) value or perform cell handover.

7. The resource configuration method according to claim 6, wherein the first uplink information comprises a Random Access CHannel (RACH) Msg1; and the method further comprises:
obtaining the TA value based on the RACH Msg1.

8. The resource configuration method according to claim 6, wherein the method further comprises at least one of the following:
sending first information to the first network node, wherein the first information is information related to an uplink resource based on which the TA value is obtained; and
sending a RACH Msg2 to the target terminal, wherein the RACH Msg2 comprises at least the TA value of the target cell.

9. The resource configuration method according to claim 7, wherein before the obtaining the TA value based on the RACH Msg1, the method further comprises:
receiving first notification information, wherein the first notification information comprises identification information of the target terminal and the configuration information of the uplink resource; and
the method further comprises:
determining, based on the first notification information, identification information of a terminal to which the TA value corresponds; and
sending second information, wherein the second information is information related to an identifier of the terminal to which the TA value corresponds.

10. The resource configuration method according to claim 6, further comprising:
receiving first notification information, wherein the first notification information comprises identification information of the target terminal and the configuration information of the uplink resource;
determining, based on the first notification information, identification information of a terminal that performs cell handover based on the uplink resource; and
when the second network node and the first network node are a same network node, determining that the terminal that performs cell handover is the target terminal.

11. The resource configuration method according to claim 7, further comprising:
sending a RACH Msg2, wherein the RACH Msg2 comprises the TA value of the target cell;
when the second network node and the first network node are different network nodes, receiving a RACH Msg3, wherein the RACH Msg3 comprises information used to carry an identifier of a terminal that performs cell handover;
determining, based on the RACH Msg3, the terminal that performs cell handover; and
sending a RACH Msg4, wherein the RACH Msg4 is scrambled by a target Radio Network Temporary Identifier (RNTI), the RACH Msg4 comprises an uplink grant for scheduling new transmission, and the target RNTI is a Cell Radio Network Temporary Identifier (C-RNTI) allocated by the target cell for the terminal that performs cell handover.

12. The resource configuration method according to claim 6, wherein when the uplink resource comprises a Physical Uplink Shared CHannel (PUSCH) resource, the first uplink information comprises PUSCH information transmitted based on the PUSCH resource and scrambled by a first common Radio Network Temporary Identifier (RNTI), and the method further comprises:
descrambling the PUSCH information on the PUSCH resource based on the first common RNTI to obtain information used to carry an identifier of a terminal that performs cell handover, wherein the first common RNTI is a common RNTI associated with the PUSCH resource;
determining, based on the information used to carry the identifier of the terminal that performs cell handover, the terminal that performs cell handover; or
sending first Physical Downlink Control CHannel (PDCCH) information, wherein the first PDCCH information is scrambled by an RNTI associated with information used to carry an identifier of the target terminal, and the first PDCCH information represents that the target terminal completes cell handover.

13. The resource configuration method according to claim 6, wherein when the uplink resource comprises a Physical Downlink Control CHannel (PDCCH) resource, the first uplink information comprises uplink control information transmitted based on a Physical Uplink Control Channel (PUCCH) resource, and the method further comprises:
sending second PDCCH information scrambled by a second common Radio Network Temporary Identifier (RNTI), wherein the second PDCCH information is used to schedule the target terminal to transmit Physical Uplink Shared CHannel (PUSCH) information on a PUSCH resource, and the second common RNTI is a common RNTI associated with the PUCCH resource;
receiving the PUSCH information; and
parsing the PUSCH information to obtain information used to carry an identifier of a terminal that performs cell handover.

14. A resource configuration method, performed by a target terminal, wherein the method comprises:
receiving a first command, wherein the first command is used to indicate the target terminal to obtain a Timing Advance (TA) value based on configuration information of an uplink resource of a target cell or perform cell handover based on configuration information of an uplink resource of a target cell, the uplink resource is shared by a plurality of terminals comprising the target terminal that are served by a first network node, and the target cell belongs to a second network node; and
sending first uplink information based on the uplink resource, wherein the first uplink information is used to obtain the TA value or perform cell handover.

15. The resource configuration method according to claim 14, further comprising:
releasing the uplink resource when the TA value is obtained or cell handover is completed.

16. The resource configuration method according to claim 14, wherein the receiving a first command comprises at least one of the following:
receiving a sent Physical Downlink Control CHannel (PDCCH) order, wherein the PDCCH order is used to indicate the target terminal to initiate contention-free random access based on the uplink resource; and
receiving a cell handover command, wherein the cell handover command is used to indicate the target terminal to perform handover to the target cell based on the uplink resource.

17. The resource configuration method according to claim 16, wherein the first uplink information comprises a Random Access CHannel (RACH) Msg1, and when the first command comprises the cell handover command, the method further comprises:
receiving a RACH Msg2, wherein the RACH Msg2 comprises the TA value of the target cell;
when the second network node and the first network node are different network nodes, sending a RACH Msg3, wherein the RACH Msg3 comprises information used to carry an identifier of the target terminal; and
receiving a RACH Msg4, wherein the RACH Msg4 is scrambled by a target Radio Network Temporary Identifier (RNTI), the RACH Msg4 comprises an uplink grant for scheduling new transmission, and the target RNTI is a Cell Radio Network Temporary Identifier (C-RNTI) allocated by the target cell for a terminal that performs cell handover.

18. The resource configuration method according to claim 14, further comprising:
receiving a Radio Resource Control (RRC) preconfiguration, wherein the RRC preconfiguration comprises at least one of the following:
an uplink resource configuration of the target cell;
identification information associated with the uplink resource configuration of the target cell; or
a common RNTI associated with the uplink resource of the target cell.

19. The resource configuration method according to claim 18, further comprising:
determining, based on the RRC preconfiguration and the first command, whether the second network node and the first network node are a same network node, wherein the RRC preconfiguration comprises a list of source cells that belong to a same network node as each target cell; and
when a source cell in which the target terminal is located is in a source cell list associated with the target cell indicated by the first command, determining that the second network node and the first network node are the same network node; or
when a source cell in which the target terminal is located is not in a source cell list associated with the target cell indicated by the first command, determining that the second network node and the first network node are different network nodes.

20. The resource configuration method according to claim 14, wherein when the uplink resource comprises a Physical Uplink Shared CHannel (PUSCH) resource, the first uplink information comprises PUSCH information transmitted based on the PUSCH resource and scrambled by a first common Radio Network Temporary Identifier (RNTI), the PUSCH information comprises information used to carry an identifier of the target terminal, and the first common RNTI is a common RNTI associated with the PUSCH resource; and the method further comprises:
receiving first Physical Downlink Control CHannel (PDCCH) information, wherein the first PDCCH information is scrambled by an RNTI associated with the information used to carry the identifier of the target terminal, and the first PDCCH information represents that the target terminal completes cell handover.
